(19) United States
(12) Patent Application Publication
(10) Pub. No.: US 2025/0162002 A1
(43) Pub. Date: May 22, 2025

(54) APPARATUS, METHODS AND SYSTEMS FOR TUBULAR INSPECTION AND/OR CLEANING

(71) Applicant: BLUEPRINT ENERGY PARTNERS, LLC, Casper, WY (US)

(72) Inventors: Kent STEVENS, Casper, WY (US); Blue JENKINS, Spanish Fork, UT (US); Van HARRIS, Bar Nunn, WY (US); David Garside SMITH, Meridian, ID (US); Cameron Christian ORR, Eagle Mountain, UT (US); Nathan James MACDONALD, Pleasant Grove, UT (US); Brandon Kevin CONLIN, Provo, UT (US)

(21) Appl. No.: 19/019,101

(22) Filed: Jan. 13, 2025

Related U.S. Application Data
(63) Continuation of application No. PCT/US2024/056233, filed on Nov. 15, 2024.
(60) Provisional application No. 63/600,393, filed on Nov. 17, 2023.

(51) Int. Cl. B08B 9/045; B08B 9/02; B08B 9/032; G01N 29/265

(52) U.S. Cl. CPC B08B 9/045; B08B 9/021; G01N 29/265; B08B 9/0325; G01N 2291/02854; G01N 2291/2636

(57) ABSTRACT

An apparatus for cleaning a tubular. The apparatus may comprise a longitudinally extending base and one or more tubular supports on top of the base for receiving the tubular from a loading path and supporting the tubular on top of the base. A first cleaner may be mounted to the base and moveable between a first loading position spaced apart from the loading path and a first cleaning position in which a first end of the tubular is received within the first cleaner for cleaning. A second cleaner mounted to the base opposite the first cleaner and moveable between a second loading position spaced apart from the loading path and a second cleaning position in which a second end of the tubular is received within the second cleaner for cleaning.

### REFERENCE TO RELATED APPLICATIONS

This application is a continuation of Patent Cooperation Treaty (PCT) application No. PCT/US24/56233 having an international filing date of 15 Nov. 2024, which in turn claims priority to, and for the purposes of the United States the benefit under 35 USC 119 in relation to, U.S. patent application No. 63/600,393 filed on 17 Nov. 2023, all of which are hereby incorporated herein by reference.

### TECHNICAL FIELD

This invention relates to inspection and/or cleaning of tubulars such as those employed in the oil and gas industry. Particular embodiments of the invention provide apparatus, method and systems for inspection and/or cleaning of tubulars.

### BACKGROUND OF THE INVENTION

Various pipes are used in the oil and gas industry, such as work string tubulars and drill pipe (collectively referred to herein as tubulars). Tubulars generally comprise a box end (e.g., a female threaded end) and a pin end (e.g., a male threaded end). Adjacent tubulars may be attached together by threading the pin end into the box end to form a connection.

Tubulars may be exposed to extreme stresses and harsh environments where failure can be critical. Moreover, such tubulars can be expensive. As such, regular maintenance of tubulars, including cleaning to prevent wear and damage, is important in order to avoid failure, increase tubular lifespan and/or reduce losses of efficiency in drilling due to dirty tubulars. Similarly, inspection for wear and damage of tubulars is important in order to avoid failure, downtime and/or reduce losses of efficiency in drilling.

Tubulars may be inspected and/or cleaned onsite (e.g., where drilling occurs) or at an offsite facility. Typically, when tubulars are inspected and/or cleaned onsite, this requires significant manual labor which involves undesirable costs and time expenditure. Further, manual labor is subject to mistakes and inconsistency.

While some systems for tubular inspection and/or cleaning exist which reduce reliance on manual labor, such systems are not easily mobile and require significant investment of time and resources to prepare a site to receive such systems (e.g. levelling and/or flattening of large areas at a drill site). In some cases, the systems are not mobile and require transportation of tubulars to a dedicated facility. Such transportation involves added cost, infrastructure and time expenditure which may negate the benefits of such systems.

There remains a general desire for effective and efficient methods and systems for onsite inspection and/or cleaning of tubulars.

The foregoing examples of the related art and limitations related thereto are intended to be illustrative and not exclusive. Other limitations of the related art will become apparent to those of skill in the art upon a reading of the specification and a study of the drawings.

### SUMMARY OF THE INVENTION

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides an apparatus for cleaning a tubular. The apparatus may comprise a longitudinally extending base and one or more tubular supports on top of the base for receiving the tubular from a loading path and supporting the tubular on top of the base. A first cleaner may be mounted to the base and moveable between a first loading position spaced apart from the loading path and a first cleaning position in which a first end of the tubular is received within the first cleaner for cleaning. A second cleaner may be mounted to the base opposite the first cleaner and moveable between a second loading position spaced apart from the loading path and a second cleaning position in which a second end of the tubular is received within the second cleaner for cleaning.

In some embodiments, the loading path extends at least partially in a transverse direction from the base. In some embodiments, the loading path extends at least partially in an upward direction from the base. In some embodiments, the loading path extends at least partially in a longitudinal direction from the base.

In some embodiments, the apparatus comprises a lift for axially aligning a first end of the tubular with the first cleaner and axially aligning a second end of the tubular with the second cleaner while the first cleaner is in the first loading position and the second cleaner is in the second loading position. In some embodiments, the lift comprises one or more lift arms for raising the tubular to axially align the first end of the tubular with the first cleaner and the second end of the tubular with the second cleaner. In some embodiments, the apparatus comprises one or more actuators, each of the one or more actuators actuatable to raise a corresponding one of the one or more lift arms to thereby raise the tubular. In some embodiments, a tubular-supporting surface of each of the one or lift arms defines a lift arm cradle for receiving the tubular. In some embodiments, the lift comprises a first lift for raising the first cleaner to axially align the first end of the tubular with the first cleaner and a second lift for raising the second cleaner to axial align the second end of the tubular with the second cleaner. In some embodiments, the apparatus comprises a first actuator actuatable to raise the first lift and a second actuator actuatable to raise the second lift.

In some embodiments, the first cleaner is moveable in the longitudinal direction between the first loading position and the first cleaning position. In some embodiments, the first cleaner is slidable in the longitudinal direction along one or more first rails between the first loading position and the first cleaning position. In some embodiments, the apparatus comprises a first cleaner actuator for moving the first cleaner in the longitudinal direction between the first loading position and the first cleaning position.

In some embodiments, the second cleaner is moveable in the longitudinal direction between the second loading position and the second cleaning position. In some embodiments, the second cleaner is slidable in the longitudinal direction along one or more second rails between the second loading position and the second cleaning position. In some embodiments, the apparatus comprises a second cleaner actuator for moving the second cleaner in the longitudinal direction between the first loading position and the first cleaning position.

In some embodiments, the first cleaner comprises a box cleaner and the first end of the tubular comprises a box end of the tubular. In some embodiments, the second cleaner comprises a pin cleaner and the second end of the tubular comprises a pin end of the tubular. In some embodiments, the first cleaner comprises a pin cleaner and the first end of the tubular comprises a pin end of the tubular. In some embodiments, the second cleaner comprises a box cleaner and the second end of the tubular comprises a box end of the tubular.

In some embodiments, the first cleaner defines a first cavity for receiving the first end of the tubular in the first cleaning position and the first cleaner comprises a first brush located in the first cavity and drivable to rotate about a first brush axis, the first brush axis extending in the longitudinal direction. In some embodiments, the first brush comprises a plurality of shoulder bristles for cleaning a shoulder of a box end of the tubular. In some embodiments, the first brush comprises and a plurality of flue bristles for cleaning the threads of the box end of the tubular.

In some embodiments, the apparatus comprises a first nozzle for directing a cleaning agent into the first cavity toward the tubular. In some embodiments, the apparatus comprises a first nozzle within the first cavity for directing a cleaning agent toward the first end of the tubular. In some embodiments, the apparatus comprises a first drain for collecting the cleaning agent in the first cavity, a separator for removing solids from the collected cleaning agent and a first pump for re-directing the cleaning agent to the first nozzle. In some embodiments, the apparatus comprises a first flexible grommet covering a substantial portion of a first opening of the first cavity, the first flexible grommet defining a first grommet opening for receiving the tubular. In some embodiments, the first flexible grommet is resiliently deformed when the tubular is received in the first grommet opening.

In some embodiments, the second cleaner defines a second cavity for receiving the second end of the tubular and the second cleaner comprises a second brush located in the second cavity and drivable to rotate about a second brush axis, the second brush axis extending in the longitudinal direction. In some embodiments, the second brush comprises a plurality of shoulder bristles for cleaning a shoulder of a pin end of the tubular. In some embodiments, the second brush comprises a plurality of thread bristles for cleaning the threads of the pin end of the tubular. In some embodiments, the second brush comprises a plurality of nose bristles for cleaning a nose of the pin end of the tubular.

In some embodiments, the apparatus comprises a second nozzle for directing a cleaning agent into the first cavity toward the tubular. In some embodiments, the apparatus comprises a second nozzle within the second cavity for directing a cleaning agent toward the second end of the tubular. In some embodiments, the apparatus comprises a second drain for collecting the cleaning agent in the second cavity, a separator for removing solids from the collected cleaning agent and a second pump for re-directing cleaning agent to the second nozzle. In some embodiments, the apparatus comprises a second flexible grommet covering a substantial portion of a second opening of the second cavity, the second flexible grommet defining a second grommet opening for receiving the tubular. In some embodiments, the second flexible grommet is resiliently deformed when the tubular is received in the second grommet opening.

In some embodiments, the one or more tubular supports comprise one or more conveying elements for conveying a tubular along a longitudinally extending conveying path. In some embodiments, the one or more conveying elements comprise a conveyor belt. In some embodiments, the conveyor belt is driven by one or more motors. In some embodiments, the one or more conveying elements comprise a plurality of rollers rotatably supported by the base, the plurality of rollers rotatable to convey the tubular in the longitudinal direction. In some embodiments, rotation of at least one of the rollers is driven by a motor. In some embodiments, at least one of the rollers comprises an idler roller. In some embodiments, each of the plurality of rollers defines a cradle for receiving at least a portion of the tubular.

In some embodiments, the second cleaner is moveable between the second loading position and a conveying position spaced apart from the longitudinally extending conveying path. In some embodiments, the second cleaner is moveable at least partially in a transverse direction between the second loading position and the conveying position, wherein the transverse direction is generally orthogonal to the longitudinal direction. In some embodiments, the second cleaner is moveable at least partially in an upward direction between the second loading position and the conveying position. In some embodiments, the second cleaner is moveable at least partially in an downward direction between the second loading position and the conveying position. In some embodiments, the second cleaner is pivotably moveable between the second loading position and the conveying position. In some embodiments, the second cleaner is slidably moveable about a longitudinally extending axis between the second loading position and the conveying position. In some embodiments, the second cleaner is slidably moveable between the second loading position and the conveying position. In some embodiments, the apparatus comprises a third actuator for moving the second cleaner between the second loading position and the conveying position.

In some embodiments, the apparatus comprises a plurality of legs individually extendible away from the base for levelling the one or more tubular supports above a ground surface. In some embodiments, each of the plurality of legs are hydraulically actuated to extend from the base. In some embodiments, the plurality of legs are individually extendible at least partially in a downward direction from the base. In some embodiments, the plurality of legs are individually extendible at least partially in a transversely outward direction from the base. In some embodiments, the plurality of legs are individually extendible at least partially in a longitudinally outward direction from the base. In some embodiments, the base defines a pair of slots for receiving forks of a fork lift to facilitate transportation of the apparatus. In some embodiments, the apparatus comprises one or more arms extending from the base in a transverse direction and pivotable about respective first and second longitudinally extending arm axes between first positions and second positions to pick up the tubular and roll the tubular along the one or more arms toward the base.

In some embodiments, the apparatus comprises one or more lifts raisable to thereby raise the tubular off of the one or more arms and direct the tubular toward the one or more tubular supports. In some embodiments, the apparatus comprises one or more lifts raisable to thereby raise the tubular off of the one or more arms and direct the tubular onto the one or more tubular supports.

In some embodiments, the apparatus comprises a thickness sensor mounted to the base for inspection of a thickness of the tubular. In some embodiments, the thickness sensor comprises an ultrasonic thickness sensor. In some embodiments, the apparatus comprises a sensor actuator to raise and lower the thickness sensor. In some embodiments, the apparatus comprises a limit switch activatable by contact of the thickness sensor with the tubular wherein when limit switch is activated, the sensor actuator stops raising the thickness sensor. In some embodiments, the lifting system comprises one or more transverse rollers contactable with the tubular, each transverse roller oriented to rotate about a respective axis extending in the longitudinal direction wherein rotation of the one or more transverse rollers causes the tubular to rotate about a longitudinal axis of the tubular while operating the thickness sensor.

Another aspect of the invention provides a portable tubular inspection unit comprising:
a towable trailer supported by a plurality of wheels and a tubular inspection device supported on the towable trailer. In some embodiments, the towable trailer comprises a cabin and the tubular inspection device is supported within the cabin of the towable trailer wherein at least one wall of the cabin of the towable trailer defines an aperture through which a tubular is receivable for inspection by the tubular inspection device. In some embodiments, the tubular inspection device comprises an electromagnetic tubular inspection device.

Another aspect of the invention provides a kit for portable tubular inspection and cleaning. The kit may comprise the tubular cleaning apparatus described herein and the portable tubular inspection unit described herein. In some embodiments, the kit comprises a second rack, wherein the second rack comprises a second longitudinally extending base and one or more second conveying elements supported by the second base for supporting and conveying a tubular in the longitudinal direction.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1A is a schematic top view depiction of an exemplary system for cleaning and/or inspection of tubulars according to an embodiment of the invention. FIG. 1B is another schematic depiction of the system for cleaning and/or inspection of tubulars according to the FIG. 1A embodiment. FIG. 1C is another schematic depiction of the system for cleaning and/or inspection of tubulars according to the FIG. 1A embodiment.

FIG. 2A is an isometric view of an exemplary rack according to an embodiment of the invention. FIG. 2B is a front view of the rack according to the FIG. 2A embodiment. FIG. 2C is a detail isometric view of a portion of the rack according to the FIG. 2A embodiment.

FIG. 3A is a top plan view of the rack of the FIG. 2 embodiment. FIG. 3B is a bottom plan view of the rack of the FIG. 2 embodiment.

FIG. 4 is an isometric view of an exemplary roller according to an embodiment of the invention.

FIG. 5 is an isometric view of an exemplary rack and an exemplary cleaning subsystem according to an embodiment of the invention.

FIG. 6 is a side view of a portion of an exemplary cleaning subsystem according to an embodiment of the invention.

FIG. 7 is a front view of the portion of the exemplary cleaning subsystem of the FIG. 6 embodiment.

FIG. 8 is a side cross-section of the portion of the exemplary cleaning subsystem of the FIG. 6 embodiment.

FIG. 9A is an isometric view of an exemplary box end brush according to an embodiment of the invention. FIG. 9B is a front schematic view of an exemplary grommet according to an embodiment of the invention.

FIG. 10A is a first side view of a portion of an exemplary cleaning subsystem according to an embodiment of the invention. FIG. 10B is a second side view of the portion of the exemplary cleaning subsystem of the FIG. 10A embodiment.

FIG. 11 is a front view of the portion of the exemplary cleaning subsystem of the FIG. 10A embodiment.

FIG. 12 is a side cross-section of the portion of the exemplary cleaning subsystem of the FIG. 10A embodiment.

FIG. 13A is an isometric view of an exemplary pin end brush according to an embodiment of the invention. FIG. 13B is a front schematic view of an exemplary grommet according to an embodiment of the invention.

FIG. 14A is a schematic isometric view depiction of an exemplary inspection unit according to an embodiment of the invention. FIG. 14B is top cross-section of the exemplary inspection unit of the FIG. 14A embodiment.

FIG. 15 is an isometric view of an exemplary rack according to an embodiment of the invention.

FIG. 16 is an isometric view of a portion of an exemplary solid liquid separator according to an embodiment of the invention.

FIG. 17A is a schematic top view depiction of an exemplary system for cleaning and/or inspection of tubulars according to an embodiment of the invention. FIG. 17B is another schematic depiction of the system for cleaning and/or inspection of tubulars according to the FIG. 1A embodiment.

FIG. 20 is an isometric view of another exemplary rack according to an embodiment of the invention.

FIG. 21A in a schematic front view of an exemplary lift of a rack supporting a tubular and a storage rack. FIG. 21B in another schematic front view of the exemplary lift and storage rack of FIG. 21A.

### DETAILED DESCRIPTION OF THE INVENTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

One aspect of the invention provides a system for tubular cleaning and/or inspection. The system may be automated or semi-automated. The system may be portable. The system may comprise a first rack for receiving one or more tubulars (e.g., from a storage rack) and for feeding the one or more tubulars into an inspection unit. A cleaning subsystem may be integrated with the first rack to allow cleaning of at least a portion of the tubular while the tubular is supported by the first rack. In some embodiments, the cleaning subsystem may allow for simultaneous cleaning of both of a pin end and a box end of a tubular supported on the first rack. The system may comprise a second rack for receiving the one or more tubulars from the inspection unit and returning the one or more tubulars to storage. Using this system, tubulars may be cleaned and inspected with minimal manual intervention.

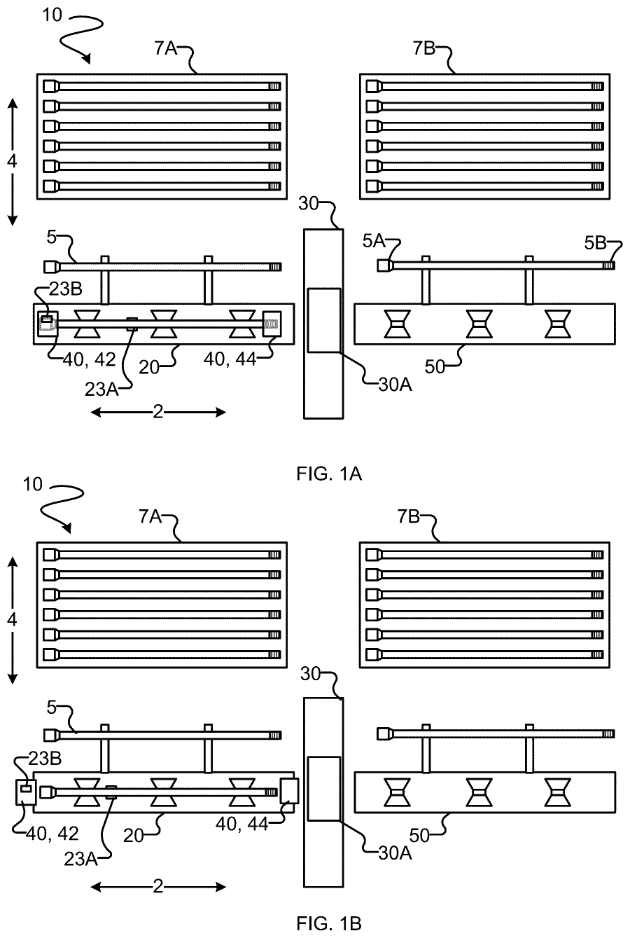

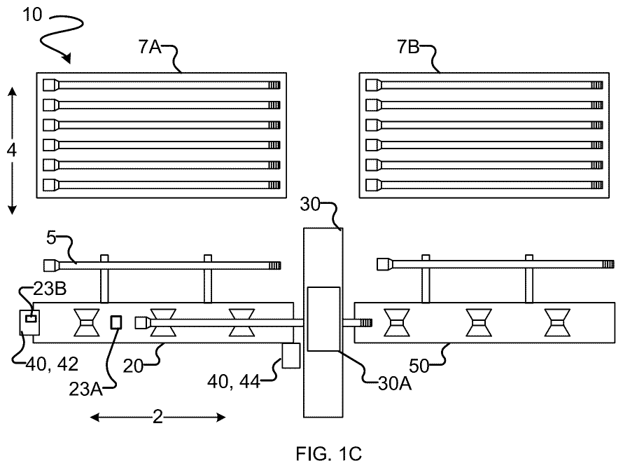

FIGS. 1A and 1B are schematic depictions of a system 10 for tubular cleaning and/or inspection. System 10 may comprise a first rack 20 for receiving tubulars 5 (e.g., from a storage rack 7A) and feeding tubulars 5 into an inspection unit 30. First rack 20 may comprise a cleaning subsystem 40 comprising a first cleaner 42 and/or a second cleaner 44 to allow cleaning of at least a portion of a tubular 5 while tubular 5 is supported by first rack 20. In some embodiments first cleaner 42 and second cleaner 44 allow for concurrent cleaning of a box end 5A and a pin end 5B of a tubular 5. First cleaner 42 may be movable between a cleaning position (as shown, for example, in FIG. 1A) to allow for cleaning of box end 5A of a tubular 5 and loading position (as shown, for example, in FIG. 1B) to allow for tubular 5 to be received on one or more conveying elements of first rack 20 and/or travel along first rack 20 (e.g., into inspection unit 30). Likewise, second cleaner 44 may be movable between a cleaning position (as shown, for example, in FIG. 1A) to allow for cleaning of pin end 5B of a tubular 5, a loading position to allow for tubular 5 to be received on one or more conveying elements of first rack 20 (as shown, for example, in FIG. 1B) and a conveying position (as shown, for example, in FIG. 1C) to allow tubular 5 to travel along first rack 20 (e.g., into inspection unit 30). System 10 may comprise a second rack 50 for receiving tubulars 5 from inspection unit 30 and returning tubulars 5 to storage (e.g., storage rack 7B). Using system 10, tubulars may be cleaned and/or inspected onsite with minimal manual intervention, as described further herein.

While first rack 20, inspection unit 30, cleaning subsystem 40 and second rack 50 are together described herein as a system (i.e., system 10), it should be understood that any one or more of such components may be implemented and or sold separately for use on its own or with other components not described herein. For example, first rack 20 and cleaning subsystem 40 may be employed for cleaning of tubulars 5 without inspection unit 30 and without second rack 50. As another example, first rack 20, inspection unit 30 and second rack 50 may be employed without cleaning subsystem 40 for inspection of tubulars 5. As another example, first rack 20 may be employed on its own for purposes other than inspecting and/or cleaning tubulars 5 or with other inspection and/or cleaning systems.

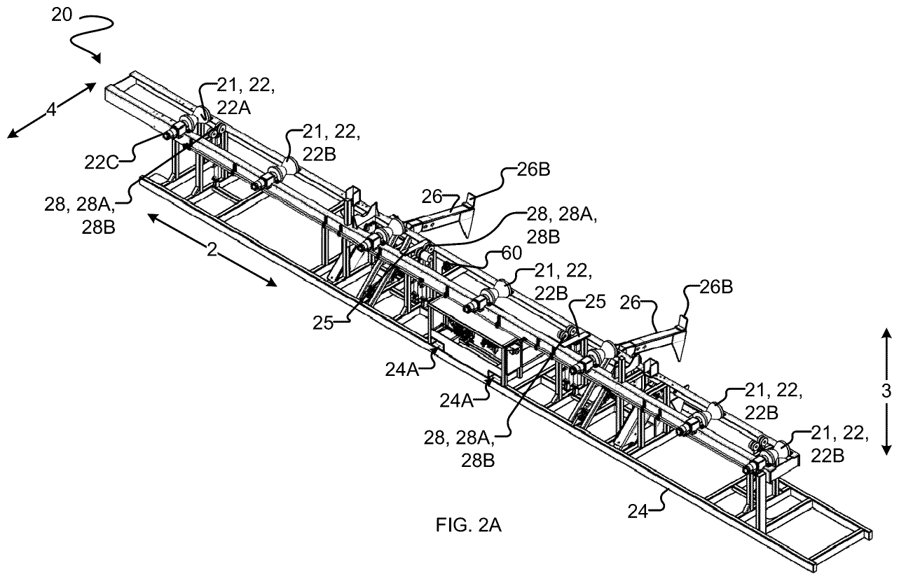

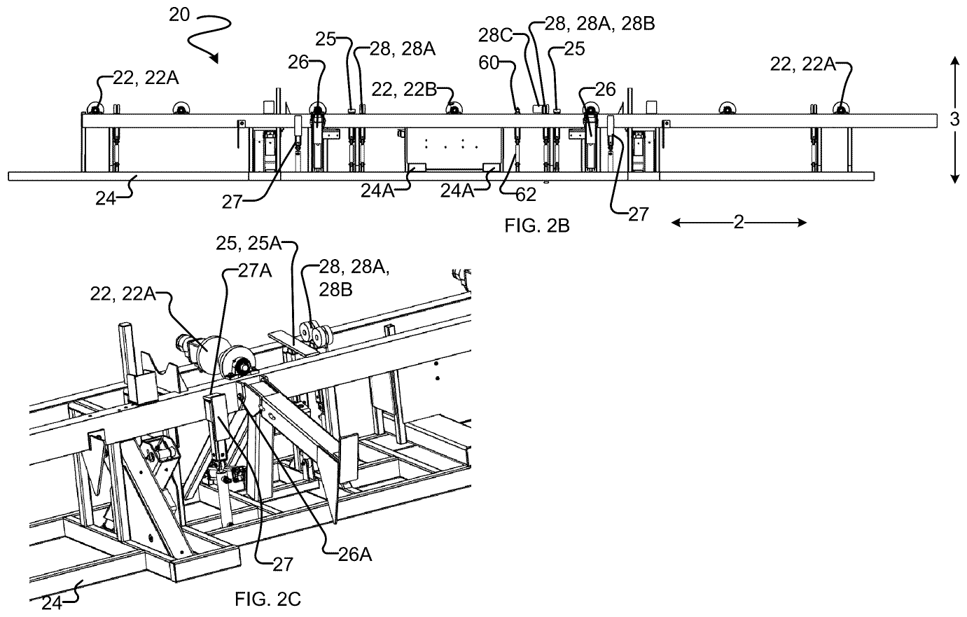

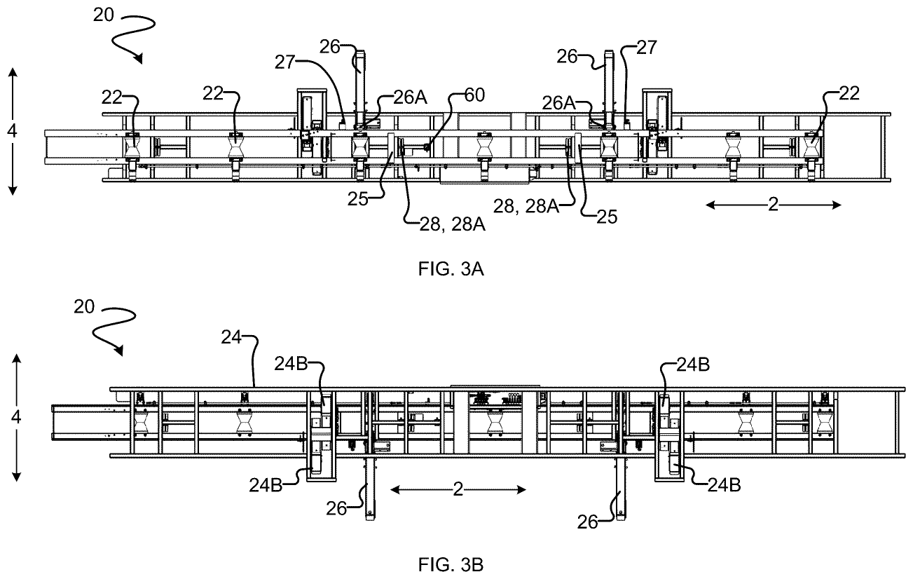

FIGS. 2A, 2B, 2C, 3A and 3B depict a first rack 20 according to an exemplary embodiment of the invention. First rack 20 comprises a longitudinally extending base 24 with one or more tubular supports. The supports may comprise, for example, one or more conveying elements 21 supported by base 24, one or more lifts (e.g., second lifts 28 described herein) or one or more stationary supports. The one or more conveying elements 21 may comprise any suitable elements for conveying a tubular in longitudinal direction 2. For example, the one or more conveying elements may comprise a conveyor belt, one or more rollers or the like. In the illustrated embodiment, the one or more conveying elements 21 comprise a plurality of rollers 22 for receiving tubulars 5, supporting tubulars 5 and conveying tubulars 5 in longitudinal direction 2. Rollers 22 may each be supported on base 24 for rotation about a respective axis extending in transverse direction 4.

Rollers 22 may comprise one or more driven rollers 22A that are driven by a drive unit 22C and optionally one or more idler rollers 22B that are free to rotate (e.g., due to friction between the roller and a tubular 5 passing over the roller). Driven rollers 22A may be driven by any suitable type of drive unit 22C such as, for example, an electric motor, a combustion motor, a hydraulic actuator, etc. In some embodiments, a single drive unit 22C may drive a plurality of the driven rollers 22A (e.g., by way of suitable gearing, chains, belts, etc.). In some embodiments, one or more driven rollers 22A may have their own drive unit 22C.

Rollers 22 may have any suitable shape. In some embodiments, rollers 22 are substantially cylindrical. In some embodiments, each roller 22 defines a cradle, channel or cut for receiving tubulars 5 and reducing (or preventing) tubulars 5 from moving substantially in transverse direction 4 when supported by rollers 22. For example, in some embodiments, a surface of each roller 22 is concave such that a radius of each roller 22 is greater near its ends than at its center.

FIG. 4 depicts an exemplary roller 22 according to an embodiment of the invention. The illustrated roller 22 comprises two conical halves 22D tapered inwardly toward each other wherein conical halves 22D meet to define a cradle 22E for receiving tubulars 5. The inward taper of conical halves 22D may facilitate catching tubulars 5 when receiving tubulars 5 from arms 26 or first lifts 27 (e.g., may reduce a risk of tubulars 5 bouncing off of rollers 22 or rolling over rollers 22).

In some embodiments, first rack 20 is portable and can be readily moved and set up onsite. To facilitate moving first rack 20, base 24 may define slots 24A shaped to receive the forks of a fork lift. By inserting the forks of a fork lift into slots 24A, a fork lift may readily lift first rack 20 thereby facilitating lifting first rack 20 off of a flatbed truck or the like and into position onsite (and up from the position onsite and onto a flatbed truck or the like).

In practice, it may be desirable to locate first rack 20 onsite in a location where the ground is not flat such that first rack 20 would not be level if a bottom surface of base 24 was resting on the ground and/or first rack 20 would not be stable which could be unsafe. To accommodate such non-flat ground, a plurality of legs 24C having feet 24B may be individually selectively extendable (and retractable) away from base 24 to support, level and stabilize first rack 20 on a ground surface (e.g., a non-flat ground surface).

Extension and retraction of each leg 24C may be, for example, hydraulically actuated, pneumatically actuated, electro-mechanically actuated or manually actuated. In some embodiments, extension and retraction of each leg 24C is manually controlled (e.g., an operator controls extension and retraction of each leg 24C until a desired height and level of first rack 20 is achieved). In some embodiments, extension and retraction of each leg 24C is automatically controllable based at least in part on input from one or more orientation sensors, positions sensors and/or height sensors (e.g. accelerometers, gyroscopes, magnetometers, optical sensors, laser sensors, etc.) to level first rack 20. Once first rack 20 is leveled, a height of first rack 20 may be adjusted by equally actuating all leg 24C. For example, a height of first rack 20 may be adjusted to accommodate a position of inspection unit 30.

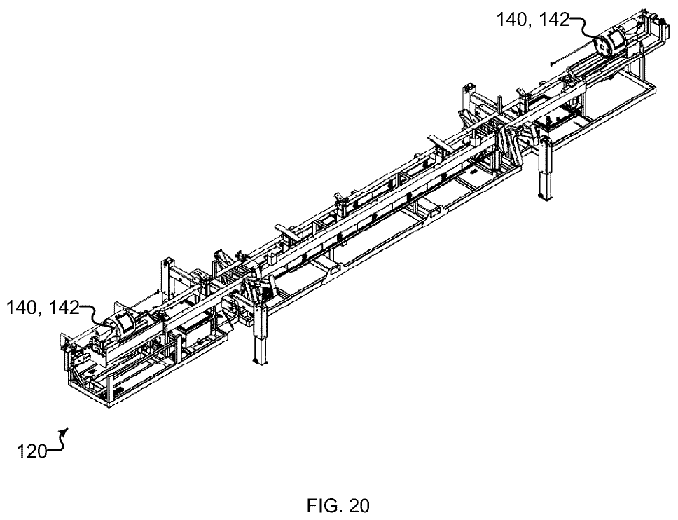

Each foot 24B may be pivotally mounted to its respective leg 24C to allow it to accommodate irregularities on the ground. In some embodiments, each leg 24C may be extendible downwardly (e.g., in downward direction 3) from base 24. In some embodiments, each leg 24C is arranged to be extendible in a direction partially downwardly (e.g., in downward direction 3) and partially outwardly (e.g., in transverse direction 4 and/or longitudinal direction 2) away from base 24. In some embodiments, each leg 24C may comprise a first part extendible outwardly (e.g., in transverse direction 4 and/or longitudinal direction 2) from base 24 and a second part extendible in downward direction 3 from base 24 (as shown in FIG. 20). Where legs 24C are extendible in transverse direction 4 and/or longitudinal direction 2 the footprint of feet 24B increases in width (e.g., increases in transverse direction 4) and/or length (e.g., increases in longitudinal direction 2) as each leg 24C is extended thereby increasing stability of first rack 20. Further, since each leg 24C is individually controllable, each leg 24C may each be extended a sufficient amount so as to raise at least a portion of base 24 off of the non-flat ground and thereby level first rack 20 in longitudinal direction 2 and/or transverse direction 4.

In practice, even where the ground under first rack 20 is flat, it may be desirable to extend legs 24C to raise first rack 20. Raising first rack 20 may have various benefits. For example, as first rack 20 is raised, the footprint of feet 24B may increase (as discussed further herein) thereby increasing stability of first rack 20. As another example, it may be desirable to raise first rack 20 to align tubulars 5 exiting first rack 20 with another apparatus (e.g., inspection unit 30).

First rack 20 may comprise one or more arms 26 for lifting tubulars 5 (e.g., off of storage rack 7A or the like) and onto first rack 20 (e.g., toward rollers 22 and/or onto rollers 22 and/or onto second lifts 28) along a loading path. This is not mandatory, in other embodiments, a separate tool (e.g., a tubular hopper, a robotic arm, a crane, a gantry, a backhoe, a forklift or the like) or manual labor may be employed to lift tubulars 5 onto first rack 20 (e.g., toward rollers 22 and/or onto rollers 22 and/or onto second lifts 28) along a loading path. The loading path may extend at least partially in transverse direction 4. The loading path may extend at least partially in upward or downward direction 3. The loading path may extend at least partially in longitudinal direction 2.

Arms 26 may extend at least partially in transverse direction 4 away from base 24. In some embodiments, arms 26 may be detachable from base 24 to reduce a size of first rack 20 to facilitate transportation of first rack 20, as discussed further herein.

Arms 26 may be movable to lift tubulars 5 (e.g., off of storage rack 7A or the like). Movement of arms 26 may be, for example, hydraulically actuated, pneumatically actuated, electro-mechanically actuated or manually actuated. In some embodiments, arms 26 may be actuated in a substantially upward direction (e.g., upward in direction 3). In some embodiments, arms 26 are pivotally mounted to base 24 such that actuation of arms 26 causes each arm 26 to pivot upwards or downwards about a respective axis 26A where each axis 26A extends in longitudinal direction 2.

A hook 26B may be provided at a distal end of each arm 26 (e.g., the end spaced apart from base 24 of first rack 20). Each hook 26B may extend generally upwardly from its respective arm 26. Each hook 26B may extend at an acute angle, at an obtuse angle or perpendicularly (or substantially perpendicularly) from its respective arm 26. Hooks 26B may facilitate catching tubulars 5 and prevent tubulars 5 from rolling off the distal ends of arms 26 when tubulars 5 are supported by arms 26.

In practice, first rack 20 may be located such that arms 26 protrude under at least a portion of storage rack 7A (or the like) such that as arms 26 are raised (e.g., pivoted) from below a tubular 5 supported by storage rack 7A, contact of arms 26 with tubular 5 causes tubular 5 to be lifted off of storage rack 7A. Hooks 26B prevent the tubular 5 from rolling off the distal ends of arms 26. As arms 26 continue to pivot upwards, arms 26 slope downward toward base 24 thereby causing tubular 5 to roll along arms 26 toward base 24. In some cases, arms 26 may lift multiple tubulars 5 at one time. In this way, arms 26 may accommodate storage racks (e.g., storage rack 7A or the like) of different heights and styles and tubulars 5 of different dimensions (e.g., different diameters and/or different lengths). Moreover, due to the configuration of arms 26, it is not necessary for a storage rack to be oriented at a precise angle relative to first rack 20 as arms 26 may accommodate such variances and tubulars 5 may be aligned as needed as tubulars 5 roll along arms 26.

In some embodiments, arms 26 may be arranged to allow tubulars 5 to roll off arms 26 and onto rollers 22. In other embodiments, tubulars 5 may be lifted off arms 26 and directed onto rollers 22.

First rack 20 may comprise one or more first lifts 27 for raising tubulars 5 off of arms 26 (e.g., at least partially in upward direction 3), as best shown in FIGS. 2B and 2C. First lifts 27 may also direct tubulars 5 toward (and onto) rollers 22 (e.g., in transverse direction 4).

First lifts 27 may be, for example, hydraulically actuated, pneumatically actuated, electro-mechanically actuated or manually actuated. In some embodiments, first lifts 27 are actuated in a substantially upward direction (e.g., upward in direction 3). In some embodiments, first lifts 27 are actuated in a direction oriented partially upward (e.g., upward in direction 3) and partially transversely toward rollers 22 (e.g., in transverse direction 4). In some embodiments, an upper tubular-receiving surface 27A of each first lift 27 is angled or tapered downward towards rollers 22 such that as tubulars 5 are lifted by first lifts 27, tubulars 5 roll off of each upper tubular-receiving surface 27A of first lifts 27 and toward or onto rollers 22.

First lifts 27 may be configured to accommodate tubulars 5 of different diameters. In some embodiments, the location of first lifts 27 relative to base 24 may be adjustable in transverse direction 4. For example, for larger diameter tubulars 5, first lifts 27 may be moved further away from base 24 in transverse direction 4 to accommodate the larger diameter. Conversely, for smaller diameter tubulars, first lifts 27 may be moved closer toward base 24 in transverse direction 4 to accommodate the smaller diameter.

First rack 20 may comprise one or more second lifts 28 for raising tubulars 5 upward (e.g., in direction 3) and off of or away from rollers 22. Second lifts 28 may be, for example, hydraulically actuated, pneumatically actuated, electro-mechanically actuated or manually actuated.

Each second lift 28 may comprise a tubular-supporting surface 28A for supporting a tubular 5 on lift 28. Like rollers 22, tubular-supporting surface 28A may define a cradle, channel or cut to prevent tubulars 5 from moving substantially in transverse direction 4 when supported by second lifts 28, but this is not mandatory. In some embodiments, surface 28A may be substantially flat. In some embodiments, surface 28A may be defined by one or more rollers 28B. In some embodiments, one or more of rollers 28B may be driven to rotate about respective axes extending in longitudinal direction 2 by one or more actuators or motors 28C.

In some embodiments, second lifts 28 are actuatable to raise tubulars 5 in order to more easily align tubulars 5 with cleaning subsystem 40. This can be advantageous to accommodate tubulars 5 having different outer diameters which would otherwise not align with cleaning subsystem 40 without some adjustment of cleaning subsystem 40. After cleaning is completed, second lifts 28 can be lowered thereby lowering tubular 5 back onto rollers 22 and tubular 5 can then be conveyed off of first rack 20 in longitudinal direction 2 (e.g., into inspection unit 30) by driving driven rollers 22A.

In some embodiments, second lifts 28 are controlled manually to align tubulars with cleaning subsystem 40. In some embodiments, second lifts 28 always raise tubular 5 by the same amount but tubular-supporting surfaces 28A are replaceable with tubular-supporting surfaces of different thicknesses to thereby accommodate tubulars 5 of different diameters. In some embodiments, a spacer may be added or removed below tubular-supporting surface 28A to accommodate tubulars 5 of different diameters. In some embodiments, operation of second lifts 28 (e.g., the height in direction 3 to which they are raised) is automated based on a known diameter of tubulars 5 being cleaned/inspected. In some embodiments, one or more sensors (e.g., ultrasonic distance meters, laser distance meters, electromechanical touch-off measurement devices, cameras, etc.) are provided to allow for automatic alignment of tubulars 5 with cleaning subsystem 40 by actuating second lifts 28 based on output of such sensors. As a batch of tubulars 5 to be cleaned and/or inspected tends to include tubulars 5 of only a single diameter, second lifts 28 may only need to be adjusted once per batch of tubulars 5.

In some embodiments, first rack 20 and/or second rack 50 may be outfitted with an integrated inspection device 60. Inspection device 60 may assist in, for example, determining a wall thickness of at least a portion of a tubular 5 supported on first rack 20. Integrated inspection device 60 may comprise, for example, one or more ultrasonic sensors mounted to base 24 of first rack 20. Inspection device 60 may be positioned to inspect wall thickness at or around a longitudinal center of tubular 5, but this is not mandatory and wall thickness may be inspected at any point along tubulars 5.

In some embodiments, inspection device 60 may inspect all or substantially all of the way around a circumference of tubular 5. In some embodiments, tubular 5 is caused to rotate about its longitudinal axis when supported on first rack 20 while inspection device 60 is fixed in position to achieve inspection of an entire circumference of tubular 5.

In some embodiments, a tubular 5 supported on first rack 20 is caused to rotate about its longitudinal axis (e.g., without substantial longitudinal direction 2 movement or transverse direction 4 movement) by driving rollers 28B supporting tubular 5 when second lifts 28 are actuated. As the tubular 5 rotates about its longitudinal axis, inspection device 60 may scan around a circumference of tubular 5 at one or more points along tubular 5. In this way, inspection of tubular 5 by inspection device 60 may be done concurrently with cleaning of tubular 5 by cleaning subsystem 40 thereby not adding time to the processing of a tubular 5. Inspection by inspection device 60 may occur in the alternative to or in addition to inspection by inspection unit 30 (discussed further herein).

In some embodiments, inspection device 60 may be mounted on an actuator 62 to raise and lower inspection device 60 to accommodate tubulars 5 of different diameters and/or to protect inspection device 60 from damage while tubulars 5 are being loaded, unloaded or conveyed. Actuator 62 may comprise any suitable actuator such as, for example, a hydraulic actuator, a pneumatic actuator, an electromechanical actuator, a manual actuator, etc.

In some embodiments, it may be desirable for inspection device 60 to contact tubular 5 while inspecting tubular 5. To prevent damage to inspection device 60 due to excessive force from contact with tubulars 5, inspection device 60 may be mounted on a limit switch where the limit switch is actuated when inspection device 60 contacts tubular 5 thereby causing actuator 62 to stop which in turn may prevent damage to inspection device 60 while allowing for tubulars 5 of differing dimensions. The limit switch may be any suitable type of limit switch such as a whisker limit switch, a roller limit switch, a roller-lever limit switch, a lever limit switch, a plunger limit switch or the like. In some embodiments, inspection device 60 is mounted on a spring-loaded axially slidable member to allow inspection device 60 to properly align with tubulars 5 of differing diameters.

In some embodiments, inspection device 60 comprises a surface preparation module for cleaning a surface of the portion of tubular 5 to be inspected by inspection device 60. The surface preparation module may comprise a rotating or oscillating brush (e.g., a wire brush), a grinding head, a sanding head, an applicator for a cleaning agent, an applicator for a surface prep agent (e.g., coupling gel) and/or the like.

In alternative embodiments, to inspect around a circumference of a tubular 5, a sensor (e.g., an ultrasonic sensor, a transducer, etc.) of inspection device 60 may be mounted to rotate around a longitudinal axis of a stationary tubular 5 when it is supported by rollers 22 or second lifts 28. Alternatively, inspection device 60 may comprise a plurality of sensors (e.g., ultrasonic sensors) spaced apart around a circumference of tubular 5 when supported by rollers 22 or second lifts 28.

In some embodiments, first rack 20 comprises one or more third lifts 25 for removing tubulars 5 from first rack 20, but this is not mandatory. Third lifts 25 may be actuatable to lift tubulars 5 upward off of rollers 22 (e.g., in direction 3) and optionally away from rollers 22 (e.g., in transverse direction 4). Third lifts 25 may be, for example, hydraulically actuated, pneumatically actuated, electro-mechanically actuated or manually actuated.

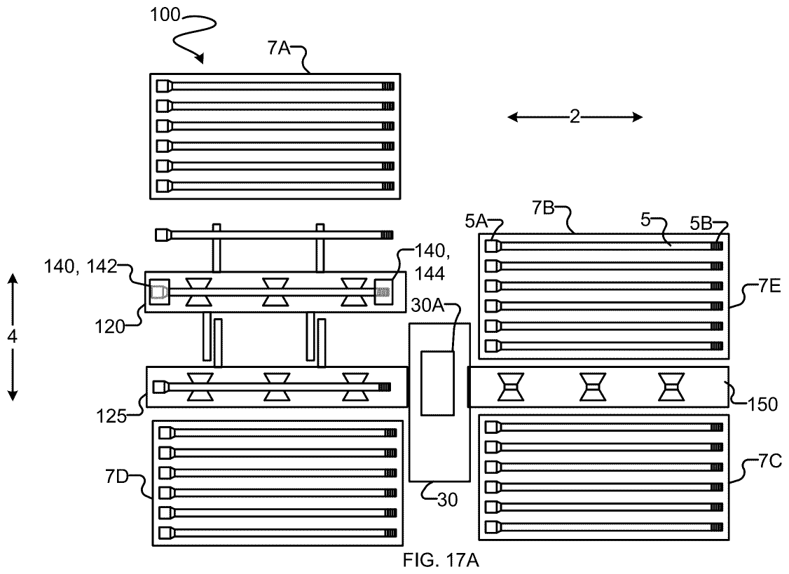

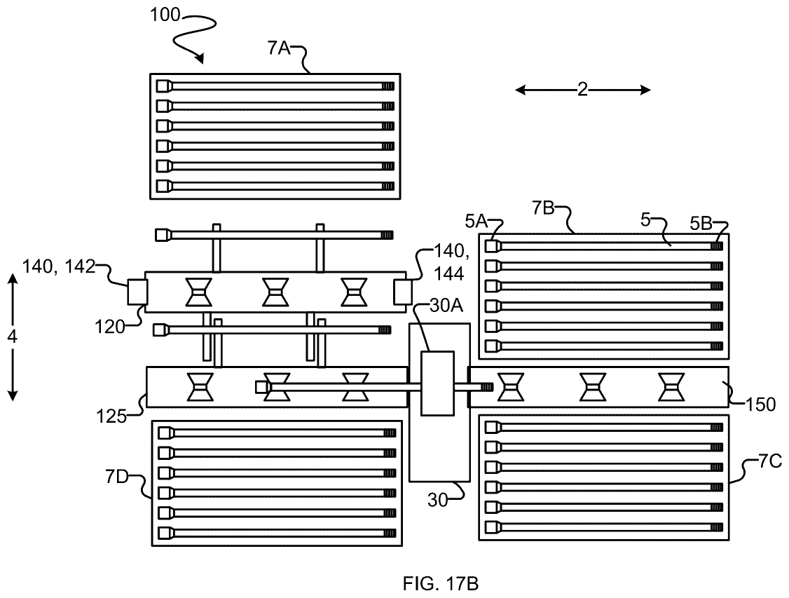

Third lifts 25 may comprise a tubular-supporting surface 25A for supporting a tubular 5 on third lifts 25. In some embodiments, tubular-supporting surface 25A may be relatively flat and optionally angled or tapered toward arms 26 so as to cause tubulars 5 to roll off third lift 25 when third lifts 25 raise tubulars 5 off of rollers 22. In some embodiments, tubulars 5 roll off of third lifts 25 when raised and onto first lifts 27 which in turn may controllably lower tubulars 5 onto arms 26. In some embodiments, tubular-supporting surface 25A may be relatively flat and optionally angled or tapered away from arms 26 so as to cause tubulars 5 to roll off third lift 25 away from arms 26 when third lifts 25 raise tubulars 5 off of rollers 22. For example, third lifts 25 may be employed to cause tubulars 5 which do not pass inspection by inspection device 60 to be placed onto a rack for rejected tubulars 5 (e.g., similar to rack 7D shown in FIGS. 17A and 17B) so that such rejected tubulars 5 do not pass through inspection unit 30.

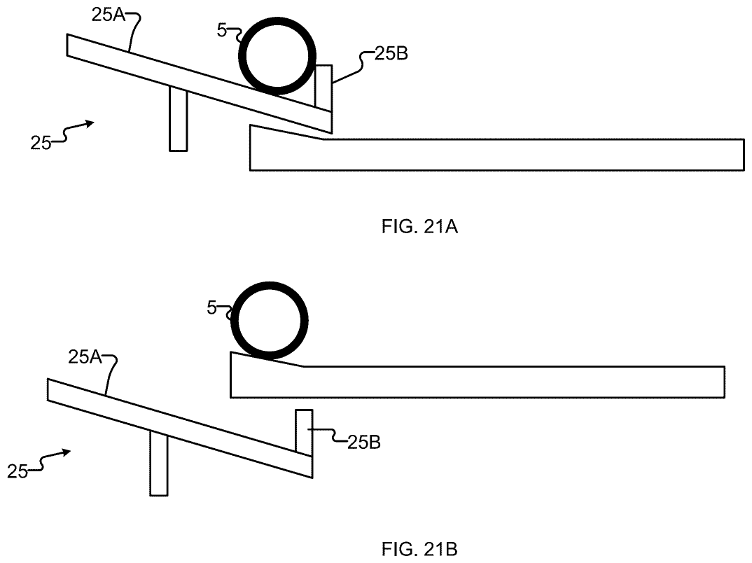

In some embodiments, each tubular-supporting surface 25A comprises a catch 25B at a bottom end thereof, as shown in FIG. 21A, to prevent tubulars 5 from rolling off tubular-supporting surface 25A thereby reducing a chance of injury caused by a falling tubular. A rack may then be arranged such that as lift 25 lowers, a tubular 5 supported by catch 25B contacts and is caught by the rack such that as lift 25 continues to lower, tubular 5 remains on the rack as shown in FIG. 21B. In some embodiments, at least a portion of the rack may be sloped to cause the tubular to roll away so as not to interfere with further raising or lowering of third lift 25.

System 10 comprises a cleaning subsystem 40. Cleaning subsystem 40 comprises a first cleaner 42 for cleaning a first end of tubular 5 and a second cleaner 44 for cleaning a second end of a tubular 5. For simplicity, first cleaner 42 is described herein as a box cleaner and may be referred to herein as box cleaner 42 but by replacing the brushes in box cleaner 42 with brushes suitable for pin ends, first cleaner 42 could be a pin cleaner. Likewise, for simplicity, second cleaner 44 is described herein as a pin cleaner and may be referred to herein as pin cleaner 44 but by replacing the brushes in pin cleaner 42 with brushes suitable for box ends, second cleaner 44 could be a box cleaner.

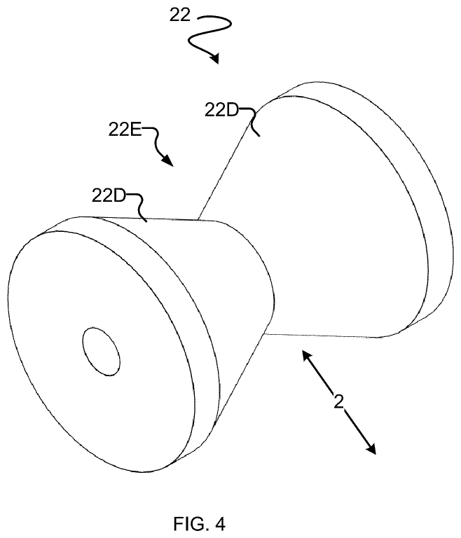

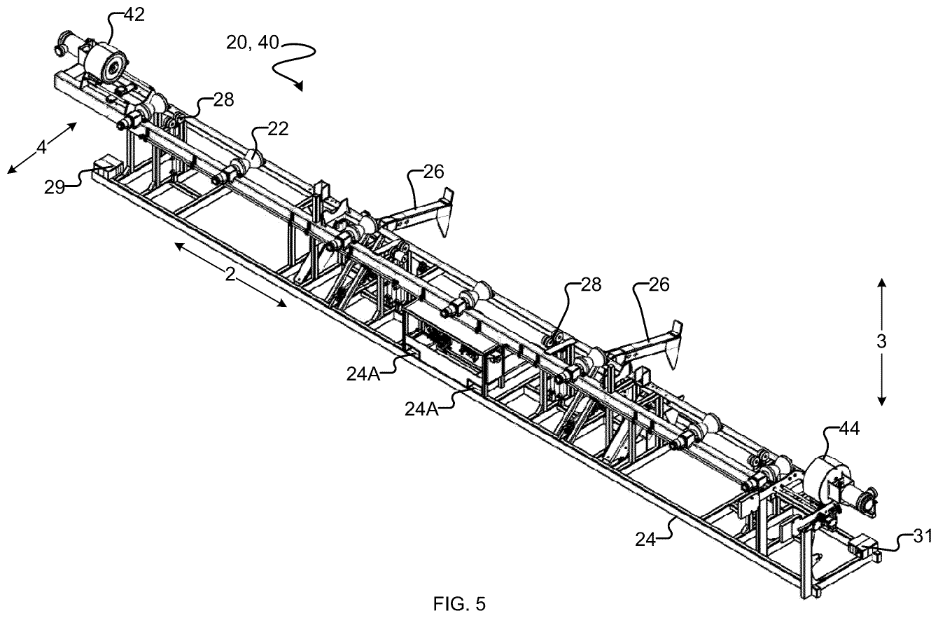

Cleaning subsystem 40 may be independently supported, mountable to any tubular support structure, conveyor or rack or mounted on any tubular support structure, conveyor or rack. For example, cleaning subsystem 40 may be mounted to first rack 20, as shown, for example, in FIG. 5. For convenience, cleaning subsystem 40 is described herein in relation to first rack 20 but it should be understood that cleaning subsystem 40 could be employed with other racks, conveyors or the like.

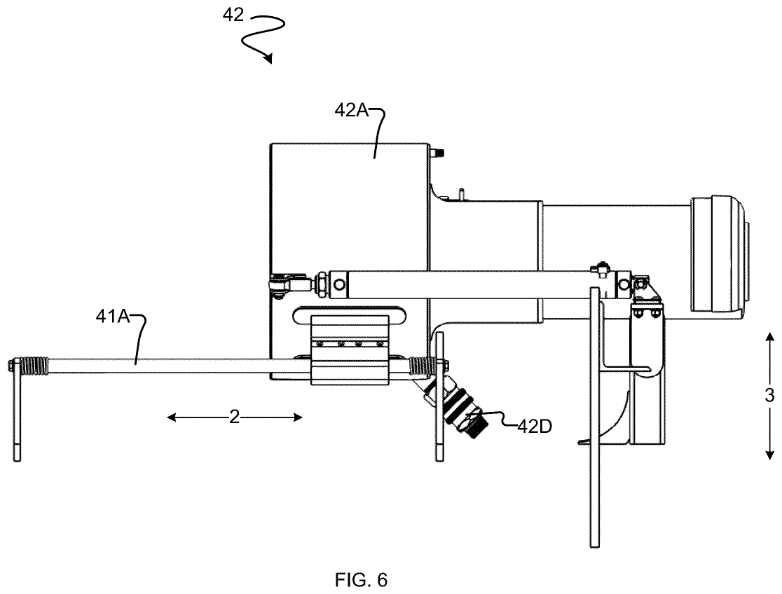

FIGS. 6, 7 and 8 depict an exemplary embodiment of a box cleaner 42 according to an embodiment of the invention. Box cleaner 42 comprises a drum 42A for receiving a box end 5A of tubulars 5. Drum 42A may house one or more brushes 43 within a cavity 42B defined by drum 42A for cleaning box end 5A of tubulars, as discussed further herein.

Box cleaner 42 may be moveable relative to base 24 of first rack 20 between a cleaning position (as shown, for example, in FIG. 1A) to allow for cleaning of box end 5A of tubular 5 and a loading position (as shown, for example, in FIG. 1B) spaced apart (e.g., in longitudinal direction 2) from the loading path of tubulars 5 to allow for a new tubular 5 to be placed onto rollers 22 (or second lifts 28) of first rack 20 without undesirably contacting box cleaner 42. In some embodiments, box cleaner 42 is moveable in longitudinal direction 2 between the cleaning position and the loading position. In some embodiments, box cleaner 42 may be translatably (e.g., slidably) mounted (or mountable) to base 24 of first rack 20 to allow box cleaner 42 to be moved in longitudinal direction 2 between the cleaning position and the loading position. Box cleaner 42 may be mounted (or mountable) to first rack 20 by way of one or more rails, tracks, guides, actuators or the like to allow for such translation or sliding of box cleaner 42 relative to base 24.

In the illustrated embodiment, box cleaner 42 is slidably mounted on a pair of longitudinally extending rails 41A. Rails 41A may in turn be mounted to base 24. Box cleaner 42 may be manually moved along rails 41A or one or more actuators, motors or the like may be employed to move drum 42A along rails 41A as desired.

Brush 43 may be rotatably mounted within drum 42A such that brush 43 may be driven to rotate about an axis extending in longitudinal direction 2. In this way, when box end 5A of tubular 5 is received in drum 42A, brush 43 may contact box end 5A and clean box end 5A as it rotates. Brush 43 may be removable to allow brush 43 to be replaced with brushes of different sizes and/or styles to thereby accommodate tubulars 5 having different dimensions (e.g., different outer and/or inner diameters). For example, brush 43 may be mounted by way of a threaded connection, a drill chuck-like connection, a keyed chuck, a keyless chuck, a hybrid chuck, a high speed collet chuck, etc.

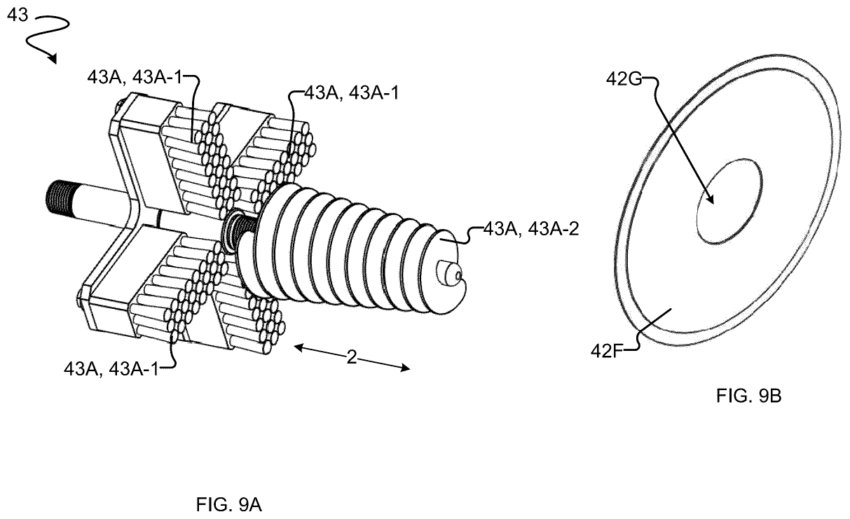

Brush 43 may have any suitable configuration. Brush 43 may be suitable for box end 5A or pin end 5B. Brush 43 may comprise a plurality of bristles, scouring pads, or other types of cleaning pads. The bristles may be metallic bristles or non-metallic bristles. For example, FIG. 9A depicts an exemplary brush 43. In the illustrated embodiment, brush 43 comprises a plurality of groups of bristles 43A. Specifically, brush 43 may comprise one or both of a group of shoulder bristles 43A-1 for cleaning a shoulder of box end 5A and a group of flue bristles 43A-2 for cleaning threads within box end 5A. Shoulder bristles 43A-1 may be arranged to point in longitudinal direction 2 when brush 43 is mounted in drum 42A for cleaning of a sealing shoulder of box end 5A of tubulars 5. In contrast, flue bristles 43A-2 may be arranged to point outwardly (e.g., radially outwardly) substantially orthogonally to longitudinal direction 2 when brush 43 is mounted in drum 42A for cleaning the threads within box end 5A of tubulars 5. In some embodiments, flue bristles 43A-2 are arranged in a helical orientation, such as is shown in FIG. 9A but this is not mandatory. In some embodiments, a radial length of flue bristles 43A-2 tapers toward a distal end of brush 43 as is shown in FIG. 9A but this is not mandatory.

As box cleaner 42 is moved in longitudinal direction 2 toward tubular 5, flue bristles 43A-2 may be inserted into box end 5A while shoulder bristles 43A-1 contact a sealing shoulder of box end 5A. As brush 43 rotates, shoulder bristles 43A-1 may clean the sealing shoulder of box end 5A of tubular 5 and flue bristles 43A-2 may clean the threads of box end 5A tubular 5.

To assist with cleaning of box end 5A of tubulars 5, one or more cleaning agents may be applied to (e.g., sprayed on or toward) box end 5A when box end 5A is inserted in drum 42A. The cleaning agent may comprise any suitable cleaning agent such as, for example, a low vapor pressure hydrocarbon based cleaning solvent. An abrasive additive may be added to the cleaning agent to improve the efficacy of brush 43. The cleaning agent(s) may be applied to box end 5A using any suitable technique or apparatus. In some embodiments, one or more nozzles 42C are spaced apart within drum 42A for spraying cleaning agent onto and/or into box end 5A when box end 5A is received in drum 42A (including potentially while brush 43 is rotating).

Nozzles 42C may be arranged in any suitable manner to spray one or more cleaning agents into cavity 42B. In some embodiments, a plurality of nozzles 42C are spaced apart circumferentially around cavity 42B and pointed inward (e.g., toward a space where box end 5A is received). This is not mandatory. In some embodiments, only one or two nozzles 42C are provided.

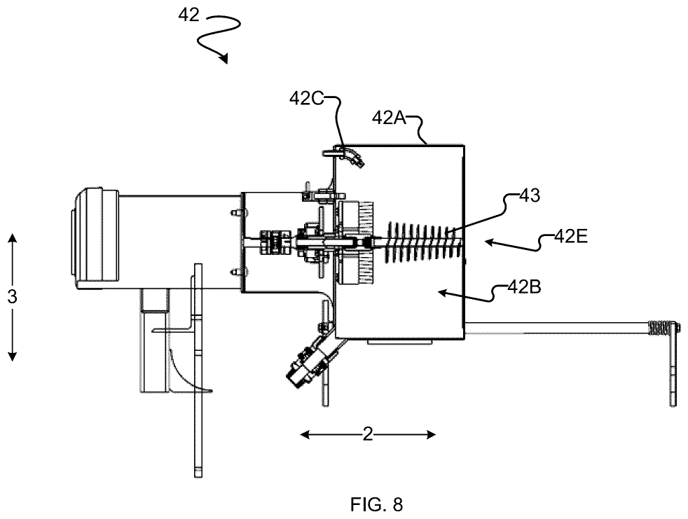

For example, in the illustrated embodiment (see, for example, FIG. 8), a single nozzle 42C is provided. In the illustrated embodiment, nozzle 42C is located near a top-most portion of cavity 42B, but this is not mandatory and nozzle 42C could be located at the bottom or near the sides of cavity 42B. In the illustrated embodiment, nozzle 42C is angled downward (in direction 3) and longitudinally inward (in direction 4) towards a space where box end 5A is received within cavity 42B. As brush 43 rotates during operation, brush 43 may serve to encourage the cleaning agent(s) to contact all parts of box end 5A even if nozzle 42C does not spray cleaning agent(s) directly onto such parts.

In some embodiments, one or more nozzles 42C may be located on brush 43 such that nozzles 42C rotate with brush 43.

A drain 42D may be provided at or near a bottom of cavity 42B to collect fluid (e.g., cleaning agent(s)) for recycling. Collected cleaning agent(s) may be stored and recirculated for re-use (e.g., collected cleaning agent(s) may delivered to nozzle(s) 42C by way of a suitable reservoir and pump or the like). Optionally, a solid-liquid separation system 29 may be provided for removing dirt, sediment or other solid material entrained in collected fluid before it is re-used. Separation system 29 may comprise any suitable type of separation system. For example, separation system 29 may comprise a centrifugal separation system, a gravity-based separation system, a filter-based separation system, a screw separation system, etc.

FIG. 16 depicts an internal portion of an exemplary separation system 29 according to an embodiment of the invention. Collected fluid enters separation system 29 through inlet 29A. Collected fluid then enters a first chamber 29B-1 of a series of chambers 29B. While the depicted embodiment comprises six chambers 29B, it should be understood that any number of chambers 29B may be provided. As collected fluid fills first chamber 29B-1, solids (sediment, dirt, etc.) fall to the bottom due to gravity and the collected fluid overflows into second chamber 29B-2 through a passage 29C near the top of first chamber 29B-1. This process continues sequentially through chambers 29B as solids are left on the bottom of chambers 29B while collected fluid overflows into a next chamber 29B until the collected fluid reaches outlet 29D and is fed back to nozzle 44C (e.g., by way of a pump—not shown).

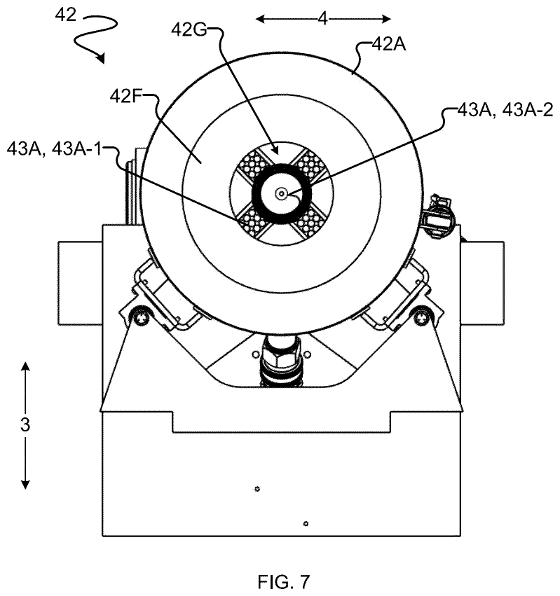

To reduce loss of cleaning agent(s) during operation, a grommet 42F (guard, cover or the like) may be provided to cover at least a portion of opening 42E of cavity 42B. Grommet 42F may define an opening 42G, as shown in FIGS. 7 and 9B, to allow box end 5A to pass in and out of cavity 42B while covering a substantial portion of opening 42E thereby reducing an amount of cleaning agent(s) lost through opening 42E. Grommet 42F may comprise a rubber, elastomer, silicon or similarly flexible material which may be resiliently deformed as box end 5A passes through opening 42G to provide a tight seal. One or more slits, perforations or the like may be provided to increase flexibility of grommet 42F. In some embodiments, grommet 42F could comprise a rigid material (e.g., grommet 42F could be an integral portion of drum 42A) and opening 42G is appropriately sized such that box end 5A may pass through opening 42G without deformation of grommet 42F.

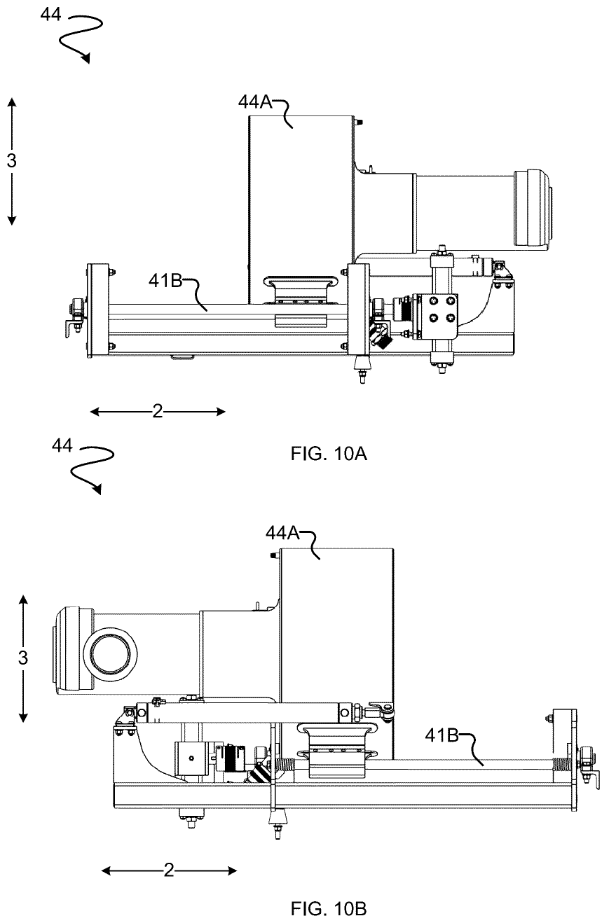

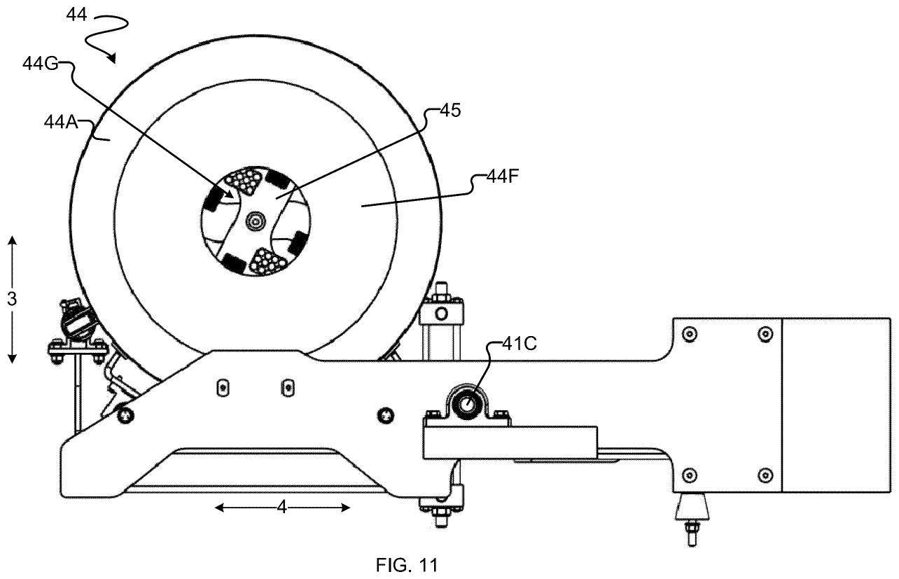

FIGS. 10, 11 and 12 depict an exemplary embodiment of a pin cleaner 44 according to an embodiment of the invention. Pin cleaner 44 may be substantially similar to box cleaner 42, except as described herein. Pin cleaner 44 comprises a drum 44A for receiving a pin end 5B of tubulars 5. Drum 44A may house one or more brushes 45 within a cavity 44B defined by drum 44A for cleaning pin end 5B of tubulars 5, as discussed further herein.

Pin cleaner 44 may be moveable relative to base 24 of first rack 20 between a cleaning position (as shown, for example, in FIG. 1A) to allow for cleaning of pin end 5B of tubular 5 and a loading position (as shown, for example, in FIG. 1B) spaced apart (e.g., in longitudinal direction 2) from the loading path of tubulars 5 to allow for a new tubular 5 to be placed onto rollers 22 (or second lifts 28) of first rack 20 without undesirably contacting pin cleaner 44. In some embodiments, pin cleaner 44 is moveable in longitudinal direction 2 between the cleaning position and the loading position. In some embodiments, pin cleaner 44 may be translatably (e.g., slidably) mounted (or mountable) to base 24 of first rack 20 to allow pin cleaner 44 to be moved in longitudinal direction 2 between the cleaning position and the loading position. Pin cleaner 44 may be mounted (or mountable) to first rack 20 by way of one or more rails, tracks, guides, actuators or the like to allow for such translation or sliding of pin cleaner 44 relative to base 24.

In the illustrated embodiment, pin cleaner 44 is slidably mounted on a pair of longitudinally extending rails 41B. Rails 41B may in turn mounted to base 24. Pin cleaner 44 may be manually moved along rails 41B or one or more actuators, motors or the like may be employed to move pin cleaner 44 along rails 41B as desired.

Pin cleaner 44 may also optionally be moveable relative to base 24 of first rack 20 between the loading position and a conveying position (as shown, for example, in FIG. 1A) spaced apart (in upward or downward direction 3 and/or transverse direction 4) from the path of tubulars 5 as they are conveyed in longitudinal direction 2 (e.g., toward inspection unit 30). In some embodiments, pin cleaner 44 may be moveably mounted (or mountable) to base 24 of first rack 20 to allow pin cleaner 44 to be moved from the loading position to the conveying position. In some embodiments, pin cleaner 44 is pivotally mounted (or mountable) to base 24 of first rack 20 to allow pin cleaner 44 to be pivoted from the loading position to the conveying position. In some embodiments, pin cleaner 44 is pivotable about an axis extending in longitudinal direction 2. For example, in the illustrated embodiment, pin cleaner 44 is pivotable about longitudinally extending axis 41C. Pin cleaner 44 may be manually pivoted about axis 41C or one or more actuators, motors or the like may be employed to pivot pin cleaner 44 about axis 41C as desired.

In some embodiments, rather than being pivotable, drum 44A is translatable (e.g., slidable) in transverse direction 4 and/or upward (or downward) direction 3 to move from the loading position to the conveying position.

Brush 45 may be rotatably mounted within drum 44A such that brush 45 may be driven to rotate about an axis extending in longitudinal direction 2. In this way, when pin end 5B of tubular 5 is inserted into drum 44A, brush 45 may contact pin end 5B and clean pin end 5B as it rotates. Brush 45 may be removable to allow brush 45 to be replaced with brushes of different sizes and/or sizes to thereby accommodate tubulars 5 having different dimensions (e.g., different outer and/or inner diameters). For example, brush 45 may be mounted by way of a threaded connection, a drill chuck-like connection, a keyed chuck, a keyless chuck, a hybrid chuck, a high speed collet chuck, etc.

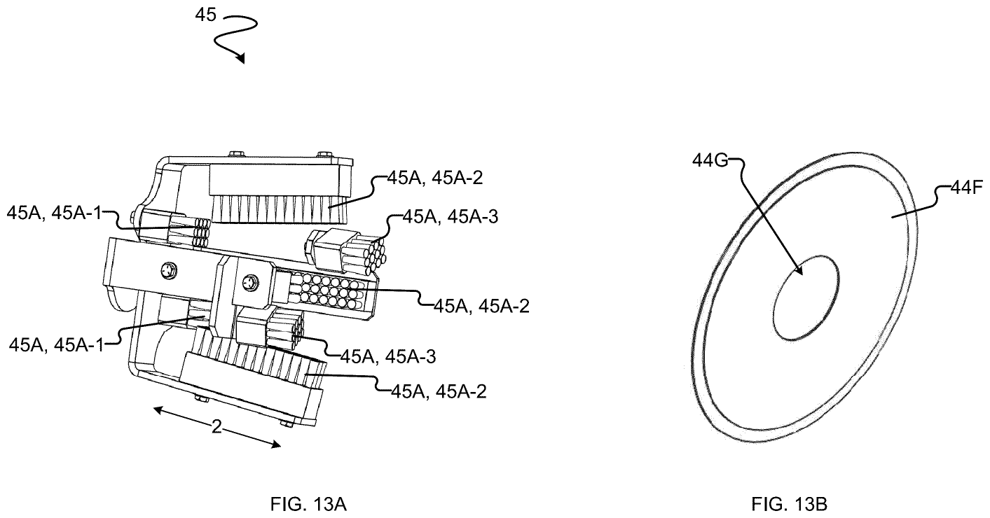

Brush 45 may have any suitable configuration. Brush 45 may be suitable for cleaning pin end 5B. Brush 45 may comprise a plurality of bristles, scouring pads, or other types of cleaning pads. The bristles may be metallic bristles or non-metallic bristles. For example, FIG. 13A depicts an exemplary brush 45. In the illustrated embodiment, brush 45 comprises a plurality of groups of bristles 45A. Specifically, brush 45 may comprise one or all of a group of nose bristles 45A-1 for cleaning a nose of pin end 5B, a group of thread bristles 45A-2 for cleaning threads of pin end 5B and a group of shoulder bristles 45A-3 for cleaning a shoulder of pin end 5B. Nose bristles 45A-1 may be arranged to point in longitudinal direction 2 when brush 45 is mounted in drum 44A for cleaning of a nose of pin end 5B of tubulars 5. In contrast, thread bristles 45A-2 may be arranged to point inwardly (e.g., radially inwardly) generally orthogonally to longitudinal direction 2 when brush 45 is mounted in drum 44A for cleaning the threads on the outside of pin end 5B of tubulars 5. Finally, shoulder bristles 45A-3 may be angled to contact a tapered shoulder of pin end 5B.

In this way, when drum 44A is moved in longitudinal direction 2 such that pin end 5B of tubular 5 is received into drum 44A, nose bristles 45A-1 may contact the nose of pin end 5B of tubular 5 thereby cleaning the nose of pin end 5B of tubular 5 as brush 45 rotates. Similarly, thread bristles 45A-2 may contact the threads of pin end 5B tubular 5 thereby simultaneously cleaning the threads of pin end 5B of tubular 5 as brush 45 rotates. Similarly, shoulder bristles 45A-3 may contact the sealing shoulder of pin end 5B of tubular 5 thereby simultaneously cleaning the sealing shoulder of pin end 5B as brush 45 rotates.

To assist with cleaning of pin end 5B of tubulars 5, one or more cleaning agents may be applied to pin end 5B when inserted in drum 44A. The cleaning agent may comprise any suitable cleaning agent such as, for example, a low vapor pressure hydrocarbon based cleaning solvent. An abrasive additive may be added to the cleaning agent to improve the efficacy of brush 45. The cleaning agent(s) may be applied to pin end 5B using any suitable technique or apparatus. In some embodiments, one or more nozzles 44C are spaced apart within drum 44A for spraying cleaning agent onto and/or into pin end 5B when pin end 5B is inserted in drum 44A (including potentially while brush 45 is rotating).

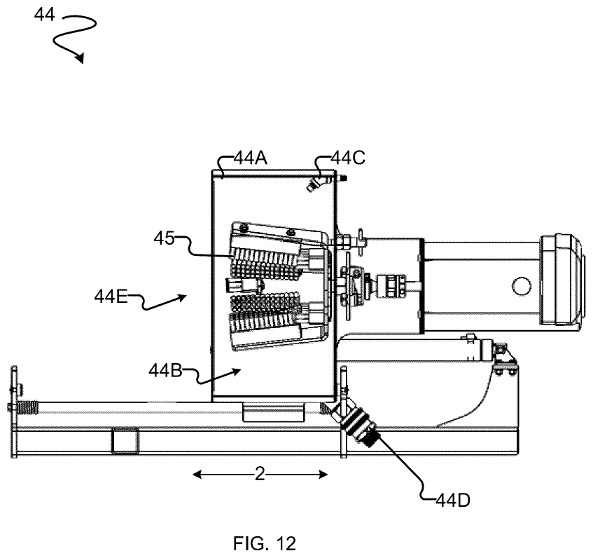

Nozzles 44C may be arranged in any suitable manner to spray one or more cleaning agents into cavity 44B. In some embodiments, a plurality of nozzles 44C are spaced apart circumferentially around cavity 44B and pointed inward (e.g., toward a space where pin end 5B is received). This is not mandatory. In some embodiments, only one or two nozzles 44C are provided. For example, in the illustrated embodiment (see, for example, FIG. 12), a single nozzle 44C is provided. In the illustrated embodiment, nozzle 44C is located near a top-most portion of cavity 44B, but this is not mandatory and nozzle 44C could be located at the bottom or near the sides of cavity 44B. In the illustrated embodiment, nozzle 44C is angled downward (in direction 3) and longitudinally inward (in direction 4) towards a space where pin end 5B is received within cavity 44B. As brush 45 rotates during operation, brush 45 may serve to encourage the cleaning agent(s) to contact all parts of pin end 5B even if nozzle 44C does not spray cleaning agent(s) directly onto such parts.

In some embodiments, one or more nozzles 44C may be located on brush 45 such that nozzles 44C rotate with brush 45.

A drain 44D may be provided at or near a bottom of cavity 44B to collect fluid (e.g., cleaning agent(s)) for recycling. Collected fluid may be recirculated for re-use (e.g., collected fluid may delivered to nozzle(s) 44C by way of a suitable reservoir and pump or the like). Collected fluid may be mixed with fluid collected from box cleaner 42. Optionally, a solid-liquid separation system 31 may be provided for removing dirt, sediment or other solid material entrained in the collected fluid before it is re-used. This solid-liquid separation system 31 may be substantially similar to separation system 29 discussed further herein. Alternatively, separation system 29 may be employed for both box cleaner 42 and pin cleaner 44.

To reduce loss of cleaning agent(s) during operation, a grommet 44F (guard, cover or the like) may be provided to cover at least a portion of opening 44E of cavity 44B. Grommet 44F may define an opening 44G, as shown in FIG. 13B, to allow pin end 5B to pass in and out of cavity 44B while covering a substantial portion of opening 44E thereby reducing an amount of cleaning agent(s) lost through opening 44E. Grommet 44F may comprise a rubber, elastomer, silicon or similarly flexible material which is resiliently deformed as pin end 5B passes through opening 44G to provide a tight seal. One or more slits, perforations or the like may be provided to increase flexibility of grommet 44F. In some embodiments, grommet 44F could comprise a rigid material (e.g., grommet 44F could be an integral portion of drum 44A) and opening 44G is appropriately sized such that pin end 5B may pass through opening 44G without deformation of grommet 44F.

Since box cleaner 42 and pin cleaner 44 are each moveable between respective loading positions and cleaning positions, a tubular 5 may be loaded onto one or more conveying elements 21 (or second lift 28) of first rack 20 by moving tubular 5 along the loading path while box cleaner 42 and pin cleaner 44 are in their respective loading positions. Box cleaner 42 and pin cleaner 44 may then be moved to their respective cleaning positions thereby allowing for simultaneous cleaning of both a box end 5A and a pin end 5B of tubular 5. As compared to conventional systems that allow only for cleaning of a single end of a tubular 5 at one time, the simultaneous cleaning of both box end 5A and pin end 5B of tubular 5 may significantly decrease the time of cleaning tubulars 5. Further, as pin cleaner 44 may also moveable into a conveying position, tubular 5 may then be conveyed off first rack 20 in longitudinal direction 2 thereby allowing for a continual processing of tubulars 5 (e.g., like an assembly line).

In some embodiments, box cleaner 42 and pin cleaner 44 may be moveable upward and/or downward by one or more lifts to facilitate aligning box cleaner 42 and pin cleaner 44 with a tubular 5 supported on first rack 20. For example, in some embodiments, box cleaner 42 and pin cleaner 44 are each mounted to an actuator for raising and lowering.

First rack 20 may comprise one or more sensors 23A to facilitate operation of first rack 20 and/or cleaning subsystem 40. These sensors may comprise force sensors, proximity sensors, optical sensors, laser distance sensors, draw wire sensors, ultrasonic distance sensors, magnetic reed sensors, and the like as the context dictates. In some embodiments, first rack 20 comprises one or more sensors for determining whether a tubular 5 is supported by arms 26. This may facilitate controlling, for example, when to raise arms 26 to roll a tubular 5 toward base 24. In some embodiments, first rack 20 comprises a sensor to determine if a tubular 5 is supported by conveying elements 21 and/or the longitudinal position of such a tubular 5 on conveying elements 21. This may facilitate controlling, for example, whether or not to drive rollers 22, whether or not to move box cleaner 42 and/or pin cleaner 44, whether or not to actuate second lifts 28, whether or not to activate inspection device 60, etc. In some embodiments, first rack 20 may comprise one or more sensors to determine the position of first lifts 27. This may facilitate, for example, ensuring that first lifts 27 are in the correct position for loading tubulars 5 onto first lifts 27. In some embodiments, first rack 20 may comprise one or more sensors to determine the position of second lifts 28. This may facilitate, for example, ensuring that second lifts 28 are in the correct position (e.g., lowered) when loading a tubular 5 onto first rack 20 and the correct position (e.g., raised according to tubular diameter) when moving box cleaner 42 and pin cleaner 44 into their respective cleaning positions). In some embodiments, first rack 20 may comprise one or more sensors to determine the position of third lifts 25. This may facilitate, for example, ensuring that third lifts 25 are in the correct position for loading tubulars 5 onto rollers 22.

Cleaning subsystem 40 may comprise one or more sensors 23B to facilitate operation of first rack 20 and/or cleaning subsystem 40. These sensors may comprise force sensors, proximity sensors, optical sensors, laser distance sensors, draw wire sensors, ultrasonic distance sensors, magnetic reed sensors, and the like as the context dictates. In some embodiments, cleaning subsystem 40 may comprise one or more sensors for determining a position of box cleaner 42 and a position of pin cleaner 44. This may facilitate, for example, ensuring that box cleaner 42 and pin cleaner 44 are in their respective loading positions when loading a tubular 5 onto first rack and/or raising a tubular 5 with second lift 28 to thereby avoid undesirable collisions. Similarly, this may facilitate, for example, determining if pin cleaner 44 is spaced apart from the conveying path of tubular 5 to thereby avoid undesirable collisions.

Inspection unit 30 may be provided for inspecting one or more structural and/or material characteristics of tubulars 5 such as, for example, fatigue cracks, corrosion, pits, cuts, washouts and wall loss.

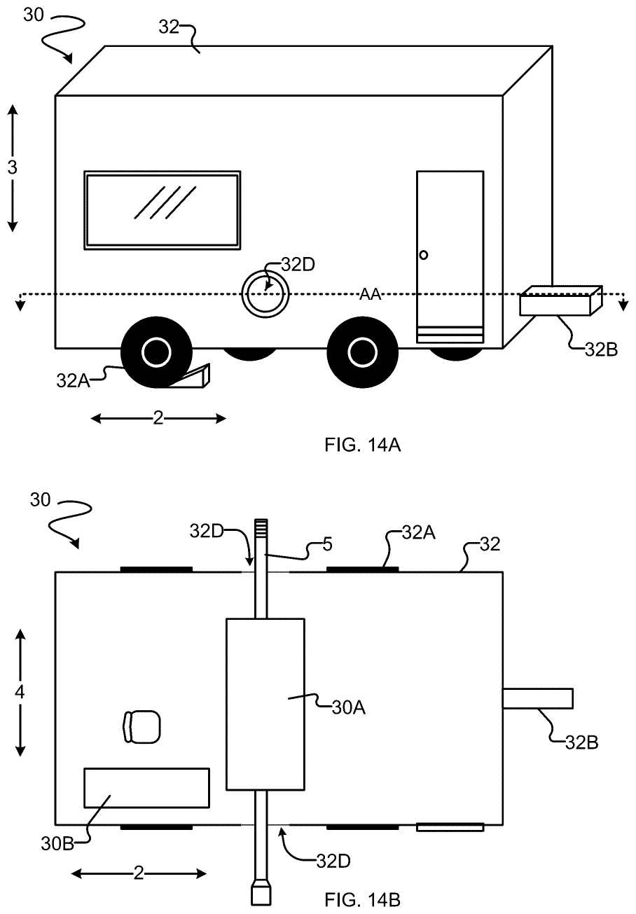

To facilitate transportation of inspection unit 30, inspection unit 30 may comprise a trailer (e.g., a bumper pull trailer) towable behind an automobile (e.g., a truck or pickup truck or the like). FIGS. 14A and 14B are schematic depictions of an inspection unit 30 comprising a trailer 32. In the illustrated embodiment, trailer 32 is supported by a plurality of wheels 32A and trailer 32 comprises a hitch mount 32B to allow trailer 32 to be connected to a vehicle and towed onsite. When located onsite, trailer 32 may be levelled using similar techniques for levelling towable recreational vehicles (commonly referred to as towable RVs) and the like such as, for example, levelling blocks (not shown), levelling jacks (not shown), etc.

Inspection unit 30 may comprise an inspection device 30A located on or within trailer 32 (e.g., within a cabin of trailer 32). Inspection device 30A may comprise, for example an electromagnetic inspection (EMI) device for inspecting tubulars 5 as they pass through the EMI device. By locating inspection device 30A within trailer 32, it may be protected from the elements (e.g., wind, rain, snow, heat, cold, etc.).

To allow tubulars 5 to be inspected by inspection device 30A, one or more walls of trailer 32 may define an aperture 32D (e.g., a pair of opposing apertures 32D as illustrated in FIG. 14B) through which tubulars 5 can pass, as shown in FIG. 14B. Aperture(s) 32D may be covered when inspection device 30A is not in use.

A control system 30B may be provided within trailer 32 to control one or more of inspection device 30A, first rack 20, cleaning subsystem 40 and second rack 50. Control system 30B may comprise one or more displays or the like for displaying output of inspection device 30A. Control system 30B may be connected to one or more of first rack 20, cleaning subsystem 40 and second rack 50 by wired connections and/or wireless connections. Control system 30B may receive output from sensors 23A and/or 23B to facilitate in manual, semi-automated or automated control of first rack 20 and/or cleaning subsystem 40 via control system 30B.

In practice, once trailer 32 is parked onsite and levelled, a fork lift may deliver first rack 20 next to trailer 32 and first rack 20 may be levelled and raised (by extending feet 24B) such that tubulars 5 conveyed from first rack 20 enter trailer 32 (and in turn enter inspection device 30A) through one of apertures 32D. As a tubular 5 is conveyed through inspection device 30A, it may eventually begin to pass through the second of the apertures 32D (e.g., as shown in FIG. 14B). As a tubular 5 is passed through the second of the apertures 32D, it may be conveyed onto second rack 50.

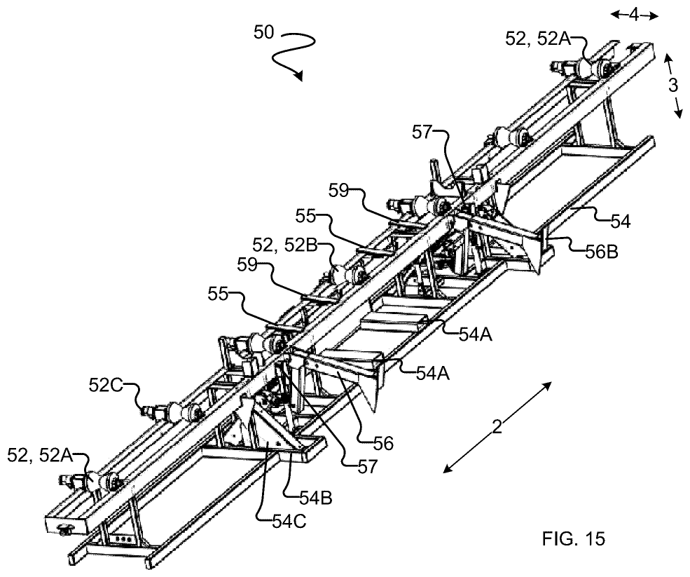

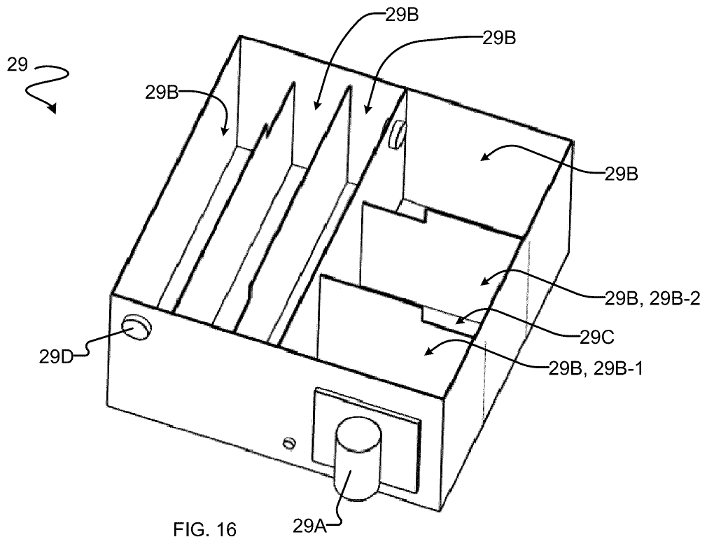

Second rack 50 may be substantially similar to first rack 20 except as described herein. FIG. 15 depicts an exemplary second rack 50 according to an embodiment of the invention. For convenience, components of second rack 50 of the FIG. 15 embodiment that are similar to components of first rack 20 use similar reference numerals (e.g., wherein the digits and trailing letters of the reference numerals of like components are the same except for the first digit which is specific to the embodiment). Unless the context or description dictates otherwise, it should be understood that when referring to features and/or characteristics of components with similar reference numerals, the corresponding description should be understood to apply to any of the particular components with such similar reference numerals.

Like first rack 20, second rack 50 may comprise a plurality of rollers 52 (comprising, for example, driven rollers 52A driven by motors 52C and idler rollers 52B) supported on a base 54. Base 54 may define slots 54A for receiving forks of a fork lift. Legs 54C and feet 54B may be selectively extendible from base 54 to raise and/or level second rack 50. Second rack 50 may optionally comprise arms 56 (having hooks 56B) substantially similar to arms 26 (having hooks 26B) and lifts 55 (substantially similar to third lifts 25). Second rack 50 may optionally comprise first lifts 57 (substantially similar to first lifts 27).

Unlike first rack 20, second rack 50 may not have a cleaning subsystem 40 attached thereto as tubulars 5 being received by second rack 50 have already been cleaned. Similarly, second rack 50 may not comprise inspection device 60 and/or second lifts 28. Second rack 50 may further comprise secondary lifts 59 substantially similar to lifts 55 except in that secondary lifts 59 may eject tubulars 5 in a direction opposite of the direction in which lifts 55 eject tubulars 5 so that, for example, tubulars 5 which do not pass inspection may be sorted separately from tubulars 5 that do pass inspection. Second rack may optionally further comprise secondary arms (not shown) substantially similar to arms 56 except in that the secondary arms extend in the opposite direction from base 54 as compared to arms 56 so that the secondary arms may function in cooperation with secondary lifts 59 to move tubulars 5 away from second rack 50.

In some embodiments, second rack 50 may comprise a painting module. The painting module may comprise a paint applicator. The paint applicator may be controlled by control system 30B to apply stripes to tubulars 5 representative of the condition of the tubular 5 as determined by system 100. The paint applicator may be moveable between a first position spaced apart from a tubular 5 supported on second rack 50 and a second position in which the paint applicator contacts a tubular 5 supported on second rack 50. Tubular 5 may be caused to rotate about its longitudinal axis while the paint applicator contacts the tubular 5 by rollers of second rack 50 substantially similar to rollers 28B such that the paint applicator can apply a stripe around a circumference of tubular 5.

For illustrative purposes, an exemplary operation of system 10 is described herein. On start-up, system 10 (or elements thereof) can perform a self-check by actuating the various actuators and making sure that the corresponding actuator position sensors respond appropriately. This self-check process may conclude by placing all actuators in their retracted states (e.g., all lifts in their lowest states and box and pin cleaners 42, 44 in their loading positions although pin cleaner 44 could in the conveying position)

Tubulars 5 may be loaded onto loading rack 7A. Loading rack 7A may have a slight downward slope on the rack such that tubulars 5 may naturally roll towards first rack 20. Alternatively, a tubular hopper system may be utilized which allows tubulars to be fed to first rack 20.

Arms 26, which are arranged to protrude at least in part under at least a closest tubular 5 may be moved upward so as to capture one or more tubulars 5 thereon. Due to the slope of arms 26, the one or more tubulars 5 may roll toward base 24 with a first tubular 5 rolling onto first lifts 27. Provided that second lifts 28 are in the down position, box and pin cleaners 42, 44 are in the loading position (or pin cleaner is in the conveying position) and no tubular 5 is detected as being currently on the first rack 20, the system may initiate actuators to raise first lifts 27 thereby raising tubular 5 and allowing tubular 5 to roll down upper tubular-receiving surface 27A onto rollers 22.

Once tubular 5 is supported by rollers 22 and detected as being present, its diameter may be ascertained, either from a pre-defined setting or by detection. This determines the height to which the tubular 5 must be raised by second lifts 28. The tubular 5 is then raised to a predetermined height in which its center is in alignment with the center of the box cleaner 42 and pin cleaner 44.

Once tubular 5 is lifted to the proper height, if inspection device 60 is present and being employed, tubular 5 may be rotated about its longitudinal axis by rollers 28B, prepared by the surface preparation module and an annular thickness reading may be taken. Optionally, it is possible that tubular 5 may fail the thickness test. In this case, tubular 5 may or may not need to be sent through inspection unit 30. However, a signal can be generated that indicates where tubular 5 passed or failed the ultrasonic thickness testing.

During or after inspection by inspection device 60, box cleaner 42 and pin cleaner 44 may be moved into their respective cleaning positions. Brushes 43 and 45 may then be rotated and cleaning agent may be sprayed via nozzles 42C, 44C for a period of time.

Once the tubular ends are cleaned box cleaner 42 and pin cleaner 44 may be moved to their respective loading positions and the brush motors turned off. It may be advantageous to keep the cleaning agent system running for a predetermined time to make sure all loosened sediment is flushed.

Tubular 5 may then be lowered back down onto rollers 22 by second lifts 28. Pin cleaner 44 can be moved to its conveying position and the tubular may be conveyed into inspection unit 30. As tubular 5 enters inspection unit 30, it may be detected by suitable sensors such as proximity or beam-splitting sensors or the like. These sensors may trigger the engagement of the clamping mechanisms associated with EMI tubular inspection systems as is well-known in the art. An automated EMI inspection process may then be carried out on the tubular as is well-known in the art. Alternatively, if as mentioned previously a signal was generated during the ultrasonic thickness testing that indicated that tubular 5 already failed inspection, the EMI inspection may be skipped and tubular 5 may simply be conveyed through the inspection unit 30 without EMI inspection. Depending on whether the tubular passed both the ultrasonic thickness testing (if incorporated) and the EMI inspection process, a pass or fail signal can be generated.

At this point the tubular is conveyed to the second rack 50. Sensors (if present) may detect the tubular 5 as it is conveyed onto second rack 50. This conveyance process may continue until a sensor signals that the tubular 5 has been fully positioned on rollers 52. Based on the pass or fail signal generated for a particular tubular 5, either a lift 55 or a secondary lift 59 (where present) may be actuated wherein lift 55 would lift the tubular such that it is permitted to roll off onto a PASS pipe rack (rack 7B) and secondary lift 59 would lift the tubular such that it is permitted to roll off onto a FAIL pipe rack (rack 7C). Thus, tubulars 5 may be divided into two (or more) groups depending on whether they passed, failed inspection, require repair, require further inspection, require further cleaning, etc.

The process may be repeated for further tubulars 5. In some embodiments, a second tubular 5 may begin this process as soon as the first tubular is removed from first rack 20.

In some embodiments, separate racks are provided for cleaning tubulars 5 and conveying tubulars 5 into inspection unit 30. For example, FIGS. 17A and 17B depict a tubular cleaning and/or inspection system 100 (referred to herein simply as “system 100”) substantially similar to tubular cleaning and/or inspection system 10 except as described herein.

Inspection system 100 comprises a cleaning rack 120 with a cleaning subsystem 140 for cleaning tubulars 5, a conveying rack 125 for conveying tubulars 5 into inspection unit 30 (and optionally passing rejected tubulars 5 onto storage rack 7D) and an output rack 150 (substantially similar to second rack 50) for receiving tubulars 5 from inspection unit 30 and offloading them onto appropriate storage racks 7C, 7E (e.g., depending on whether they pass inspection or not).

FIG. 18 depicts an exemplary cleaning rack 120 with a cleaning subsystem 140 mounted thereto. Cleaning rack 120 may be substantially similar to first rack 20 except as described herein. Likewise, cleaning subsystem 140 may be substantially similar to cleaning subsystem 40 except as described herein.

Cleaning subsystem 140 comprises a box cleaner 142 (substantially similar to box cleaner 42) and a pin cleaner 144 (substantially similar to pin cleaner 42). Like box cleaner 42, box cleaner 142 may be moveable relative to a base of cleaning rack 120 between a cleaning position (as shown, for example, in FIG. 17A) to allow for cleaning of box end 5A of tubular 5 and a loading position (as shown, for example, in FIG. 17B) spaced apart (e.g., in longitudinal direction 2) from the loading path of tubulars 5 to allow for a new tubular 5 to be placed onto cleaning rack 120 without undesirably contacting box cleaner 142. Like pin cleaner 44, pin cleaner 144 may be moveable relative to a base of cleaning rack 120 between a cleaning position (as shown, for example, in FIG. 17A) to allow for cleaning of pin end 5B of tubular 5 and a loading position (as shown, for example, in FIG. 17B) spaced apart (e.g., in longitudinal direction 2) from the loading path of tubulars 5 to allow for a new tubular 5 to be placed onto cleaning rack 120 without undesirably contacting pin cleaner 144.

As cleaning rack 120 is not employed to convey tubulars 5 into inspection unit 30, cleaning rack 120 may not comprise conveying elements like conveying elements 21. Similarly, as cleaning rack 120 is not employed to convey tubulars 5 into inspection unit 30, pin cleaner 144 may not be configured to move into a conveying position like pin cleaner 44. However, as cleaning rack 120 may need to eject tubulars 5 toward conveying rack 125, cleaning rack 120 may comprise secondary lifts (not shown) substantially similar to secondary lifts 59 described herein.

Conveying rack 125 may be substantially similar to cleaning rack 120 except as described herein. However, since conveying rack 125 is not employed to clean tubulars, conveying rack 125 may not have a cleaning subsystem like cleaning subsystems 40, 140.

In some embodiments, one or more inspection devices (e.g., substantially similar to inspection device 60) are provided on one or both of cleaning rack 120 and conveying rack 125. Where such inspection devices are provided on both cleaning rack 120 and conveying rack 125, they may be located so as to inspect different longitudinal spaced apart portions of tubulars 5.

In practice, system 100 is operated in a similar manner to how system 100 is operated except in that tubulars 5 are first loaded onto cleaning rack 120 (similar to how tubulars 5 loaded onto first rack 20) where they are cleaned before then being loaded onto conveying rack 125 for conveying into inspection unit 30 (or passing onto storage rack 7D where inspection is failed). By separating the cleaning and conveying functions, system 100 may be simplified as compared to system 100 thereby reducing costs and/or facilitate automation thereof.

Together, the elements of tubular cleaning and/or inspection systems 10, 100 facilitate and simplify installation of systems 10, 100 at a drill site. For example, while traditional tubular cleaning/inspection systems require levelling of a large area for receiving equipment, systems 10, 100 may be placed on uneven ground since, as discussed herein, inspection unit 30 can be levelled using methods standards for recreational vehicles and first and second racks 20, 50 may then be levelled and raised to match a height of inspection unit 30 by employing the integrated levelling capabilities of first and second racks 20, 50 discussed further herein.

Further, the elements of tubular cleaning and/or inspection systems 10, 100 facilitate and simplify transportation of system 10 to and from the drill site. For example, inspection unit 30 can be towed to and from the drill site and due to the size and shape of first and second racks 20, 50, they may be fit together on a single flatbed trailer for transportation to and from the drill site (e.g., by disconnecting arms 26 and arms 56). However, despite the narrow (transverse direction 4) footprint of first and second racks 20, 50, which allows them to fit together on a flatbed trailer, first and second racks 20, 50, can still be sufficiently stable during operation due to the outward nature of the extension of feet 24B, as discussed further herein.

Further still, the elements of tubular cleaning and/or inspection systems 10, 100 may increase a speed at which tubulars 5 may be cleaned and inspected as systems 10, 100 allow for a continuous process in which tubulars 5 are continually loaded onto first rack 20, cleaned (both box end 5A and pin end 5B simultaneously), conveyed to inspection unit 30 and then conveyed onto second rack 50 for re-racking without any backtracking and with minimal manual input. Additionally, a thickness of tubular 5 may optionally be inspected by inspection device 60 during that same time as cleaning.

### Interpretation of Terms

Unless the context clearly requires otherwise, throughout the description and the
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

While processes or blocks are presented in a given order, alternative examples may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed in parallel, or may be performed at different times.
In addition, while elements are at times shown as being performed sequentially, they may instead be performed simultaneously or in different sequences. It is therefore intended that the following claims are interpreted to include all such variations as are within their intended scope.

Where a component is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.
Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).
It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. An apparatus for cleaning a tubular, the apparatus comprising:
a longitudinally extending base;
one or more tubular supports on top of the base for receiving the tubular from a loading path and supporting the tubular on top of the base;
a first cleaner mounted to the base and moveable between a first loading position spaced apart from the loading path and a first cleaning position in which a first end of the tubular is received within the first cleaner for cleaning; and
a second cleaner mounted to the base opposite the first cleaner and moveable between a second loading position spaced apart from the loading path and a second cleaning position in which a second end of the tubular is received within the second cleaner for cleaning.

2. The apparatus according to claim 1 wherein the loading path extends at least partially in a transverse direction from the base.

3. The apparatus according to claim 1 wherein the loading path extends at least partially in an upward direction from the base.

4. The apparatus according to claim 1 comprising a lift for axially aligning a first end of the tubular with the first cleaner and axially aligning a second end of the tubular with the second cleaner while the first cleaner is in the first loading position and the second cleaner is in the second loading position.

5. The apparatus according to claim 4 wherein the lift comprises one or more lift arms for raising the tubular to axially align the first end of the tubular with the first cleaner and the second end of the tubular with the second cleaner.

6. The apparatus according to claim 4 wherein the lift comprises a first lift for raising the first cleaner to axially align the first end of the tubular with the first cleaner and a second lift for raising the second cleaner to axial align the second end of the tubular with the second cleaner.

7. The apparatus according to claim 1 wherein the first cleaner is moveable in the longitudinal direction between the first loading position and the first cleaning position and the second cleaner is moveable in the longitudinal direction between the second loading position and the second cleaning position.

8. The apparatus according to claim 1 wherein:
the first cleaner defines a first cavity for receiving the first end of the tubular in the first cleaning position and the first cleaner comprises a first brush located in the first cavity and drivable to rotate about a first brush axis, the first brush axis extending in the longitudinal direction; and
the second cleaner defines a second cavity for receiving the second end of the tubular and the second cleaner comprises a second brush located in the second cavity and drivable to rotate about a second brush axis, the second brush axis extending in the longitudinal direction.

9. The apparatus according to claim 8 wherein the first brush comprises a plurality of shoulder bristles for cleaning a shoulder of a box end of the tubular and a plurality of flue bristles for cleaning the threads of the box end of the tubular.

10. The apparatus according to claim 8 comprising:
a first nozzle within the first cavity for directing a cleaning agent toward the first end of the tubular; and
a second nozzle within the second cavity for directing a cleaning agent toward the second end of the tubular.

11. The apparatus according to claim 10 comprising:
a first flexible grommet covering a substantial portion of a first opening of the first cavity, the first flexible grommet defining a first grommet opening for receiving the tubular; and
a second flexible grommet covering a substantial portion of a second opening of the second cavity, the second flexible grommet defining a second grommet opening for receiving the tubular.

12. The apparatus according to claim 8 wherein the second brush comprises a plurality of shoulder bristles for cleaning a shoulder of a pin end of the tubular; a plurality of thread bristles for cleaning the threads of the pin end of the tubular; and a plurality of nose bristles for cleaning a nose of the pin end of the tubular.

13. The apparatus according to claim 1 wherein the one or more tubular supports comprise one or more conveying elements for conveying a tubular along a longitudinally extending conveying path.

14. The apparatus according to claim 13 wherein the one or more conveying elements comprise a plurality of rollers rotatably supported by the base, the plurality of rollers rotatable to convey the tubular in the longitudinal direction wherein rotation of at least one of the rollers is driven by a motor.

15. The apparatus according to claim 13 wherein the second cleaner is moveable between the second loading position and a conveying position spaced apart from the longitudinally extending conveying path.

16. The apparatus according to claim 15 wherein the second cleaner is moveable at least partially in a transverse direction between the second loading position and the conveying position, wherein the transverse direction is generally orthogonal to the longitudinal direction.

17. The apparatus according to claim 15 wherein the second cleaner is pivotably moveable between the second loading position and the conveying position.

18. The apparatus according to claim 1 comprising a plurality of legs individually extendible away from the base for levelling the one or more tubular supports above a ground surface.

19. The apparatus according to claim 1 comprising an ultrasonic thickness sensor mounted to the base for inspection of a thickness of the tubular.

20. The apparatus according to claim 19 comprising one or more transverse rollers contactable with the tubular, each transverse roller oriented to rotate about a respective axis extending in the longitudinal direction wherein rotation of the one or more transverse rollers causes the tubular to rotate about a longitudinal axis of the tubular while operating the thickness sensor.
